(19) United States
(12) Patent Application Publication
(10) Pub. No.: US 2009/0213447 A1
(43) Pub. Date: Aug. 27, 2009

(54) LIGHT BEAM SCANNING DEVICE

(75) Inventor: Kenichi Hayashi, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 11/994,161

(22) PCT Filed: Jun. 26, 2006
(86) PCT No.: PCT/JP2006/312717

§ 371 Date: Mar. 2, 2009

(30) Foreign Application Priority Data
Jun. 28, 2005 (JP) 2005-188995

(51) Int. Cl. G02B 26/12

(52) U.S. Cl. 359/216.1

(57) ABSTRACT

A light beam scanning device may include a light source device, and an optical deflection mechanism for scanning a light beam which is emitted from the light source device over a prescribed angular range by an optical deflection element. The light source device may be provided with a light emitting source and a condenser lens for guiding the light beam emitted from the light emitting source as a converged light beam which is focused on the optical deflection element or its vicinity in at least one of a first direction and a second direction which are perpendicular to an optical axis direction. The light beam scanning device may further include a divergence angle modification lens for varying a divergence angle of an emitted light beam from the optical deflection element in at least a direction perpendicular to a scanning direction by the optical deflection element.

### TECHNICAL FIELD

The present invention relates to a light beam scanning device for scanning a light beam emitted from a light source device in a prescribed direction.

### BACKGROUND ART

Conventionally, light beam scanning devices have been widely used in an image forming device such as a laser printer, a digital copying machine and a facsimile, or a bar code reading device, an inter-vehicle distance measuring device and the like. In a light beam scanning device used in an image forming device, a light beam emitted from a laser beam emitting element such as a laser diode is periodically deflected by a polygon mirror to periodically scan on a surface to be scanned of a photosensitive body. On the other hand, in a measuring device, information is detected by receiving a reflected light beam with a photo-detector in which the reflected light beam is a scanning light beam emitted from a light beam scanning device and reflected by an object to be irradiated. In this case, the reflected beam is directed to the photo-detector at an incidence angle corresponding to a scanning angle by the polygon mirror. With regard to an optical deflection element, except that a polygon mirror is rotated, there is a method in which a light beam is scanned over a constant angular range by a reflector plate which is swung.

A light beam irradiated to a polygon mirror or a reflector plate is a light beam whose divergence degree of the light beam emitted from the light source is made smaller to some extent through a collimating lens. An incidence area to the polygon mirror or the reflector plate is an effective diameter on a reflection surface for the light beam, which determines a size of the polygon mirror or the reflector plate (see Patent References 1 and 2).
[Patent Reference 1] Japanese Patent Laid-Open No. Hei 11-14922
[Patent Reference 2] Japanese Patent Laid-Open No. Hei 11-326806

However, in the conventional light beam scanning device, a diameter of a light beam which is incident on a polygon mirror is large, the polygon mirror is required to have a further larger size. Therefore, in the conventional light beam scanning device, since a size of the polygon mirror cannot be reduced, there are problems that a light beam scanning device cannot be miniaturized and productivity of the polygon mirror is low. Further, when a polygon mirror will be manufactured by utilizing resin molding, shrinkage easily occurs and it is difficult to improve productivity and yield. Moreover, when the polygon mirror is driven by a motor, it is difficult to be balanced to cause a jitter characteristic to deteriorate.

On the other hand, in a system for swinging a reflector plate, there has been proposed to utilize a silicon substrate and a torsion spring for driving with an electro-magnetic force or an electrostatic force with the use of silicon micro machining technique. This technique is effective to form a fine region. However, like a conventional case, when a light beam having a large diameter is used, cost is extremely increased and the merits of a microminiaturized reflector plate cannot be utilized.

In view of the problems described above, the present invention may provide a light beam scanning device in which a size of an optical deflection element such as a polygon mirror can be reduced and a divergence angle of a scanning light beam can be set satisfactorily.

In order to solve the problems as described above, according to at least an embodiment of the present invention, a light beam scanning device may include a light source device, and an optical deflection mechanism for scanning a light beam which is emitted from the light source device over a prescribed angular range by an optical deflection element. The light source device is provided with a light emitting source and a condenser lens for guiding the light beam emitted from the light emitting source as a converged light beam which is focused on the optical deflection element or its vicinity in at least one of a first direction and a second direction which are perpendicular to an optical axis direction. The light beam scanning device further includes a divergence angle modification lens for varying a divergence angle of an emitted light beam from the optical deflection element in at least a direction perpendicular to a scanning direction by the optical deflection element.

In at least an embodiment of the present invention, the light source device emits a converged light beam which is focused on the optical deflection element or its vicinity in at least one of a first direction and a second direction which are perpendicular to an optical axis direction. Therefore, a spot formed on the optical deflection element is small in at least one of the first direction and the second direction and thus a size of the optical deflection element can be reduced. Accordingly, productivity of the optical deflection element can be enhanced and an optical deflection element can be provided in which, for example, the number of scanning points can be increased by utilizing the latest micronization technique. Further, when the size of the optical deflection element is reduced, balance when it is driven is improved. Therefore, optical scanning with a high degree of accuracy can be performed and a size of a drive mechanism such as a motor for driving the optical deflection element can be reduced. In the present invention, when it is premised that the condenser lens emits a light beam, which is emitted from a light emitting source, as a converged light beam focused on the optical deflection element or its vicinity, there is a case that a divergence angle in a direction perpendicular to the scanning direction of the light beam emitted from the optical deflection element cannot be set in a prescribed condition. However, according to the present invention, the divergence angle in a direction perpendicular to the scanning direction can be set in a prescribed condition by the divergence angle modification lens. Accordingly, in a case that optical designing is performed in which a light beam emitted from a light emitting source is focused on an optical deflection element or its vicinity, even when miniaturization designing where a distance between optical components is shortened or the like is performed, a light beam can be scanned whose divergence angle in the direction perpendicular to the scanning direction is in a prescribed condition.

In at least an embodiment of the present invention, it is preferable that the light emitting source is a laser beam emitting element. When a laser beam emitting element is used as the light emitting source, an incident light beam to the optical deflection element can be made small and thus a size of an optical system can be reduced.

In at least an embodiment of the present invention, it is preferable that the divergence angle modification lens varies the divergence angle of the emitted light beam from the optical deflection element only in a direction perpendicular to the scanning direction. When the divergence angle modification lens does not affect on the scanning direction, designing of the optical deflection element is easy. Further, even in a case that environment temperature is varied to vary optical characteristics of the divergence angle modification lens, when the divergence angle modification lens does not affect on the scanning direction, a stable scanning can be performed. In at least an embodiment of the present invention, the word “only” in the phrase “only in a direction perpendicular to the scanning direction” means 100% in design but also includes a case of incomplete 100% having a power that does not affect.

In at least an embodiment of the present invention, it is preferable that the divergence angle modification lens is a cylindrical lens. When a cylindrical lens is used as the divergence angle modification lens, a divergence angle is adjusted in only one of the scanning direction and the direction perpendicular to the scanning direction and thus the divergence angle in the other direction can be prevented from being affected.

In at least an embodiment of the present invention, it is preferable that the divergence angle modification lens is a toric lens or a toroidal lens whose light incidence face is a cylindrical face where a radius of curvature in the scanning direction is set to be equal to a distance between the optical deflection element and the light incidence face and, in which a radius of curvature in the scanning direction of its light emitting face is set to be equal to a distance between the optical deflection element and the emitting face. According to this structure, in comparison with a case that a cylindrical lens is used as the divergence angle modification lens, a divergence angle is adjusted in only one of the scanning direction and the direction perpendicular to the scanning direction and thus the divergence angle in the other direction can be prevented from being affected.

In at least an embodiment of the present invention, it is preferable that a divergence angle modification lens drive mechanism is provided for driving the divergence angle modification lens to move a scanning position of the light beam in a direction crossing the scanning direction. According to this structure, a plurality of scanning lines can be structured.

In at least an embodiment of the present invention, for example, the divergence angle modification lens drive mechanism changes an inclination posture of the divergence angle modification lens around an axial line which is parallel to the scanning direction.

In at least an embodiment of the present invention, the condenser lens is, for example, one of an aspherical lens, a toric lens, a toroidal lens and a cylindrical lens, at least one face of which is provided with a positive power.

In at least an embodiment of the present invention, it is preferable that one face of the condenser lens is provided with a condensing operation in the first direction and the other face of the condenser lens is provided with a condensing operation in the second direction. When combined with various lens shape as described above, desired condensing performances (for example, focal length, condensing/divergence angle and beam intensity distribution) or desired divergence performances (for example, condensing/ divergence angle and beam intensity distribution) can be realized.

In at least an embodiment of the present invention, it is preferable that the condenser lens and the divergence angle modification lens are made of resin. According to this structure, a weight of the light beam scanning device can be reduced by a reduced weight of the lens. Further, since productivity of the lens can be improved, cost of the light beam scanning device can be reduced.

In at least an embodiment of the present invention, the optical deflection mechanism includes, for example, a polygon mirror in a multi-angular column shape as the optical deflection element and a drive mechanism for rotating the polygon mirror around its axial line. In this light beam scanning device, a size of the polygon mirror can be reduced.

In at least an embodiment of the present invention, it is preferable that the light beam emitted from the light emitting source is focused through the condenser lens on the polygon mirror or its vicinity in a direction perpendicular to a rotation shaft of the polygon mirror of the first direction and the second direction. According to this structure, a size of the polygon mirror can be reduced.

In at least an embodiment of the present invention, it is preferable that the light beam emitted from the light emitting source is focused through the condenser lens on the polygon mirror or its vicinity in both a direction perpendicular to a rotation shaft of the polygon mirror and a direction parallel to the rotation shaft of the polygon mirror of the first direction and the second direction. According to this structure, a size of the polygon mirror can be further reduced.

In at least an embodiment of the present invention, the optical deflection mechanism includes an optical deflection disk as the optical deflection element and a rotational drive mechanism for rotationally driving the optical deflection disk, and an emitting direction of the light beam which is incident on the optical deflection disk is varied according to a position in a circumferential direction of a disk face of the optical deflection disk. According to the optical deflection disk having the structure as described above, effects of surface wobbling due to rotation which affect on jitter characteristics are low. Further, since the optical deflection disk having the structure as described above is in a simple structure, productivity and quality stability are high.

In at least an embodiment of the present invention, the optical deflection disk is, for example, a transmission type optical deflection disk through which a direction of the incident light beam is transmitted and emitted is varied according to the position in the circumferential direction of the disk face.

In at least an embodiment of the present invention, the optical deflection disk is a reflection type optical deflection disk by which a direction of the incident light beam is reflected and emitted is varied according to the position in the circumferential direction of the disk face.

In at least an embodiment of the present invention, the optical deflection disk is provided with a plurality of optical deflection regions which is divided in the circumferential direction of the disk face, and the plurality of the optical deflection regions is formed with an inclined face through which the incident light beam is emitted to a direction different from directions in adjacent optical deflection regions.

In this case, it is preferable that the plurality of the optical deflection regions are radially divided in the circumferential direction. According to this structure, a stable beam scanning can be performed only by rotating the optical deflection disk.

In at least an embodiment of the present invention, it is preferable that the disk face of the optical deflection disk is formed with one or plural optical deflection regions which is provided with an inclined face for continuously varying an emitting direction of the incident light beam in the circumferential direction. According to this structure, a beam can be smoothly scanned over a prescribed range only by rotating the optical deflection disk.

In at least an embodiment of the present invention, the inclined face inclines, for example, to a radial direction and an emitting direction of the light beam is varied in the circumferential direction by an inclination angle to the radial direction of the inclined face which is varied in the circumferential direction. According to this structure, a shape of the respective inclined faces is structured as a simple conical surface and thus its manufacturing is easy.

In at least an embodiment of the present invention, it may be structured that the inclined face inclines to the circumferential direction and an emitting direction of the light beam is varied in the circumferential direction by an inclination angle to the circumferential direction of the inclined face which is varied in the circumferential direction.

In at least an embodiment of the present invention, it is preferable that the light beam emitted from the light emitting source is focused through the condenser lens on the optical deflection disk or its vicinity in the circumferential direction of the optical deflection disk of the first direction and the second direction. According to this structure, a size of the optical deflection disk can be reduced.

In at least an embodiment of the present invention, it is preferable that the light beam emitted from the light emitting source is focused through the condenser lens on the optical deflection disk or its vicinity in both the radial direction and the circumferential direction of the optical deflection disk of the first direction and the second direction. According to this structure, a size of the optical deflection disk can be reduced.

In the light beam scanning device in accordance with at least an embodiment of the present invention, a spot formed on the optical deflection element is small in at least one of the first direction and the second direction and thus a size of the optical deflection element can be reduced. Therefore, productivity of the optical deflection element can be enhanced and an optical deflection element can be provided in which, for example, the number of scanning points can be increased by utilizing the latest micronization technique. Further, when the size of the optical deflection element is reduced, balance when it is driven is improved. Therefore, optical scanning with a high degree of accuracy can be performed and a size of a drive mechanism such as a motor for driving the optical deflection element can be reduced. In addition, the divergence angle in a direction perpendicular to the scanning direction can be set in a prescribed condition by the divergence angle modification lens. Therefore, in a case that optical designing is performed in which a light beam emitted from a light emitting source is focused on an optical deflection element or its vicinity, even when miniaturization designing where a distance between optical components is shortened or the like is performed, a light beam whose divergence angle in a direction perpendicular to the scanning direction is in a prescribed condition can be scanned.

### BRIEF DESCRIPTION OF THE DRAWINGS

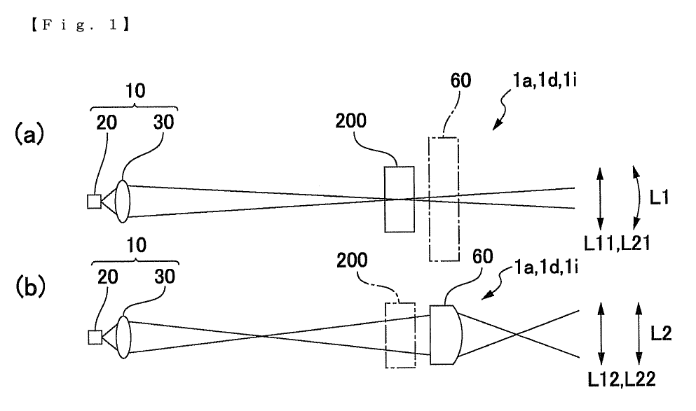

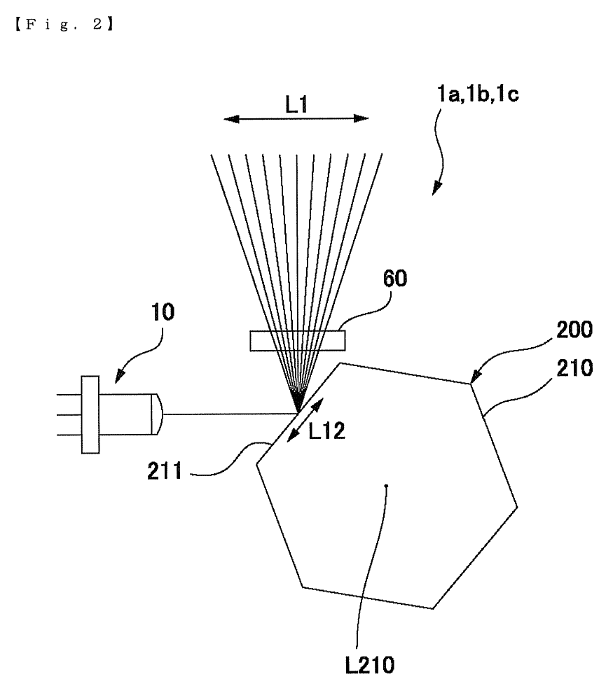

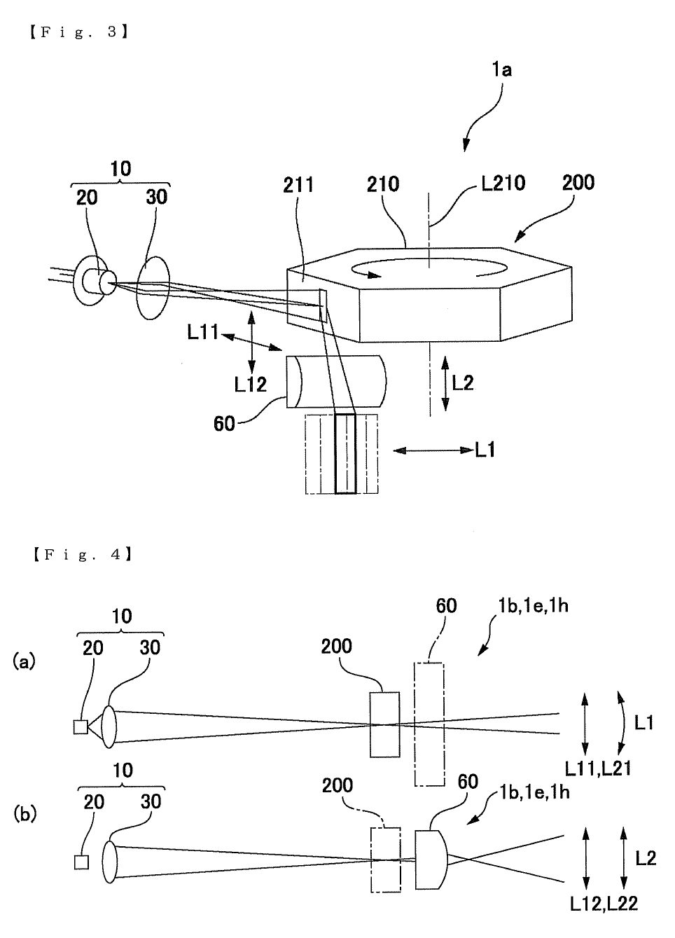

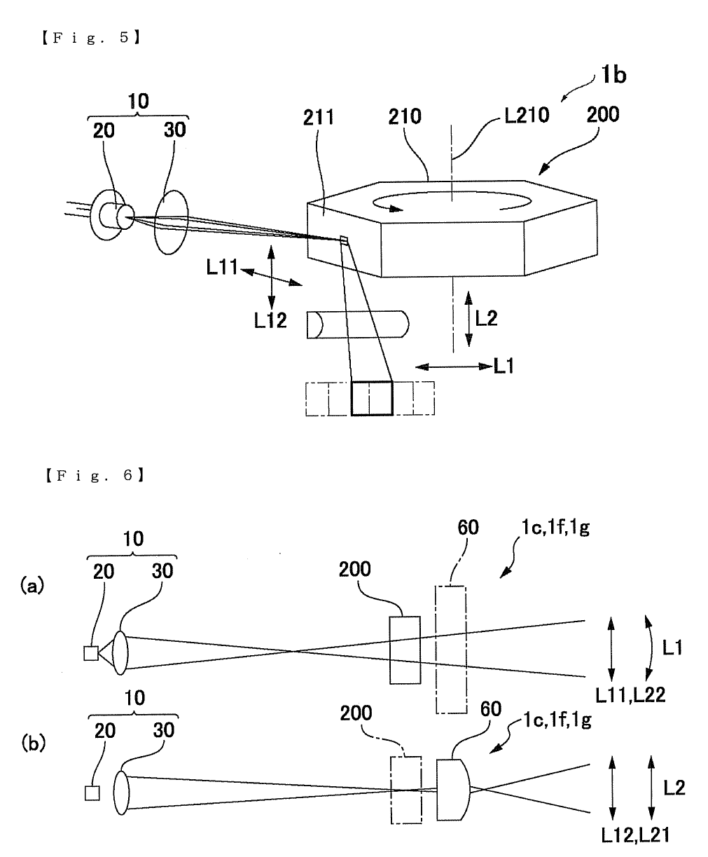

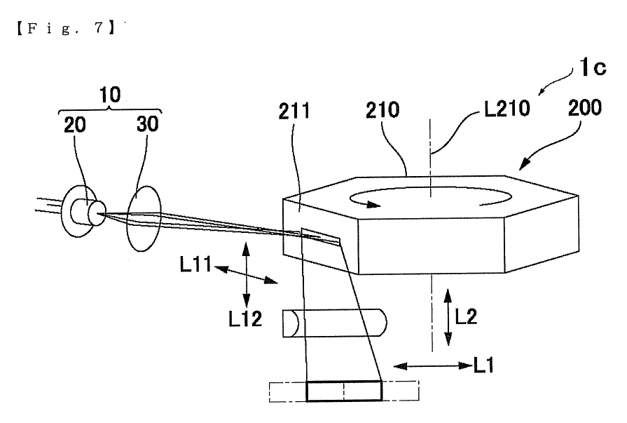

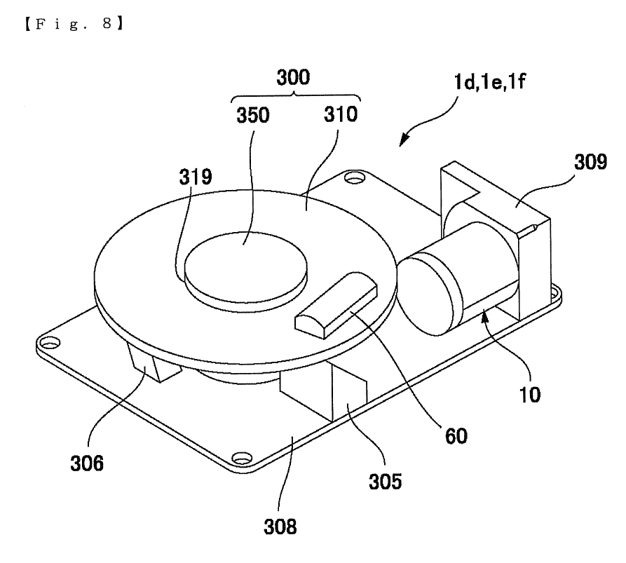

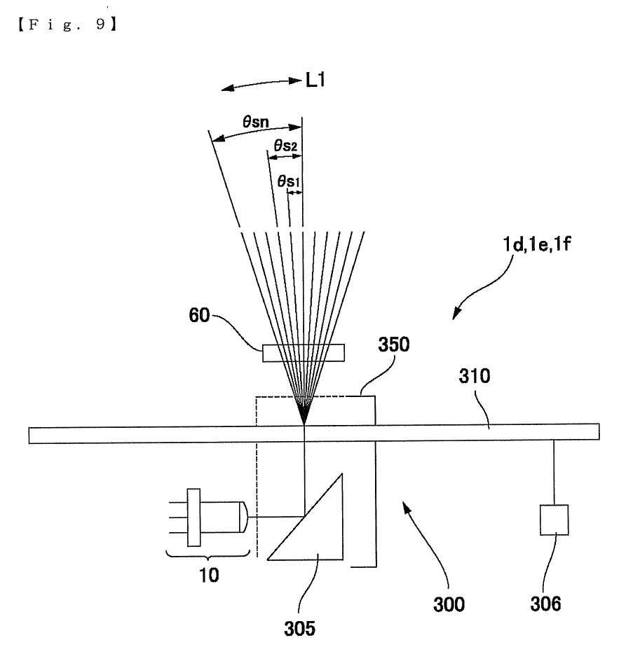

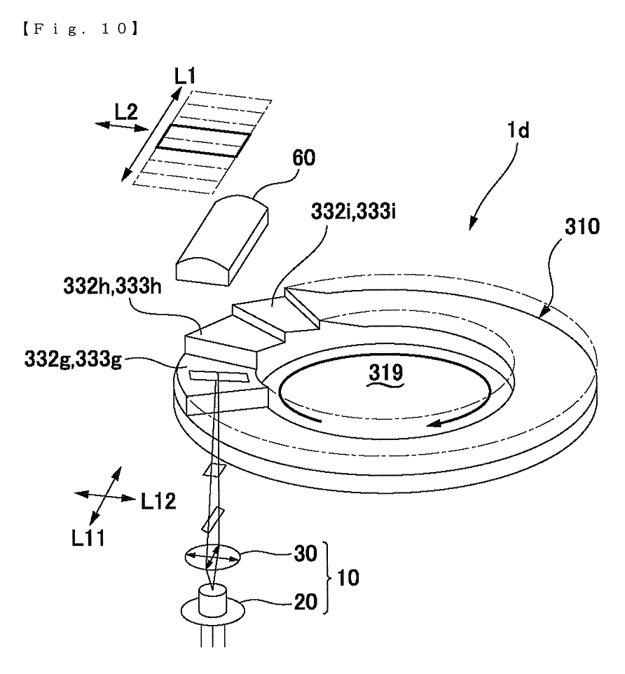

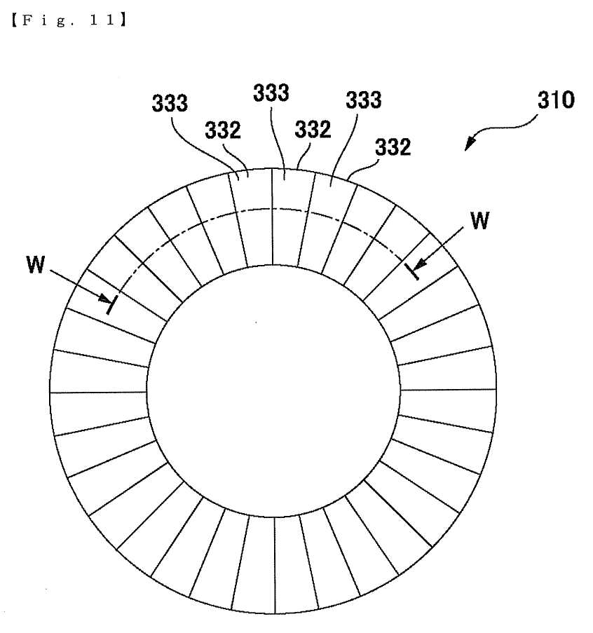

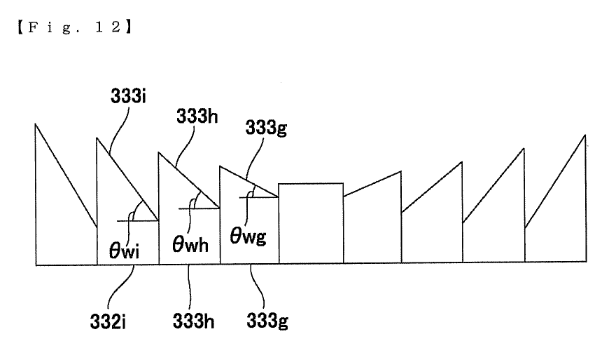

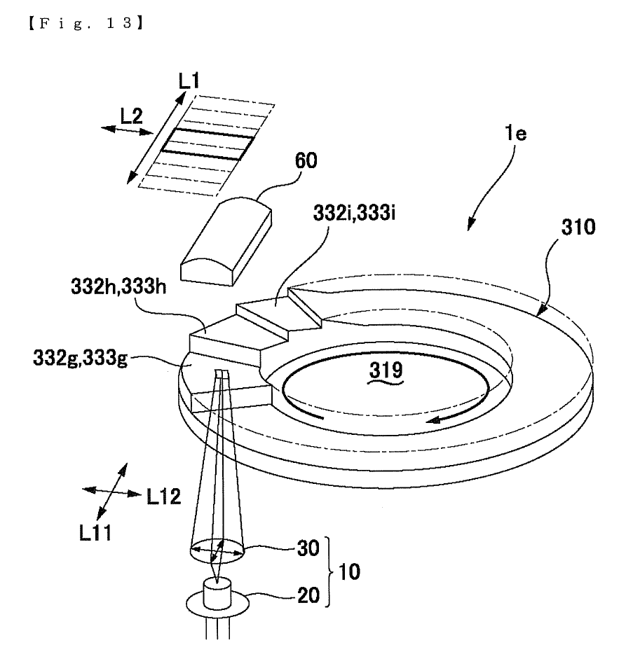

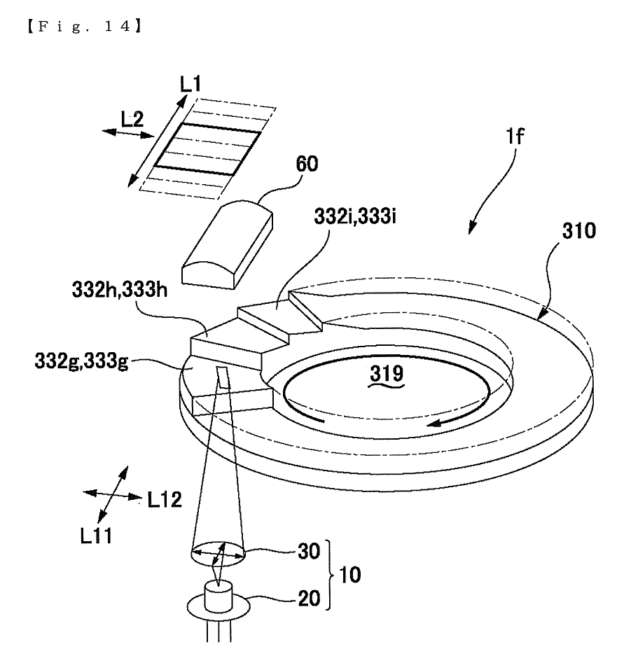

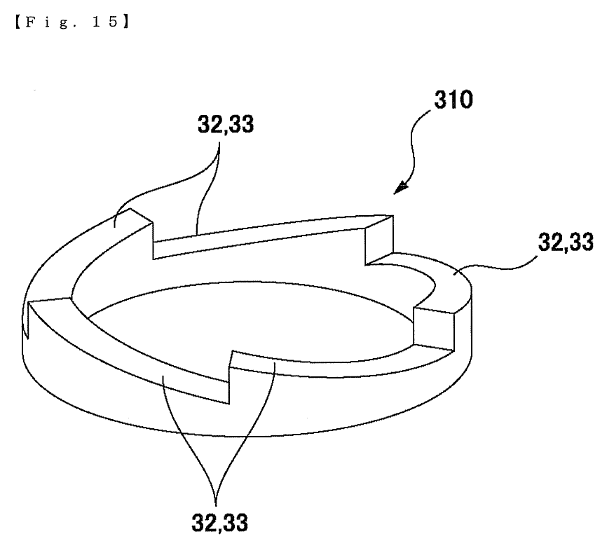

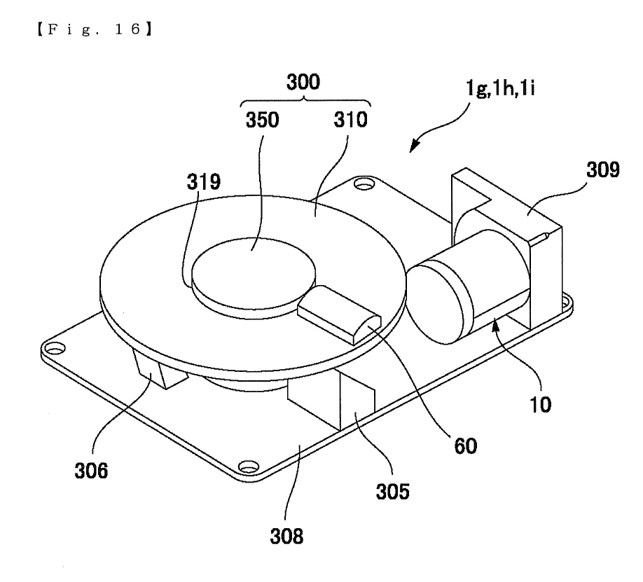

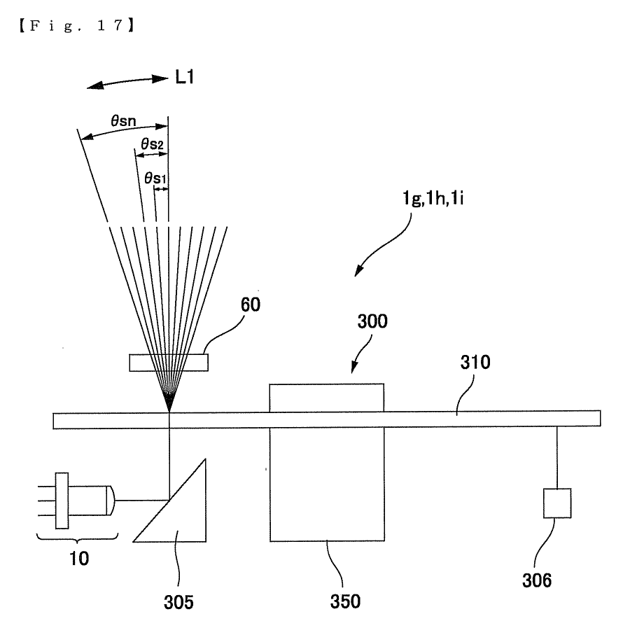

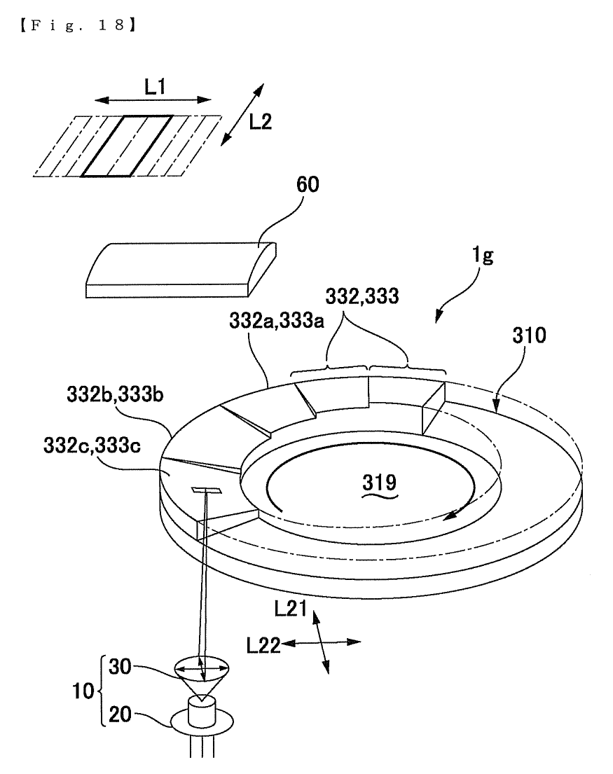

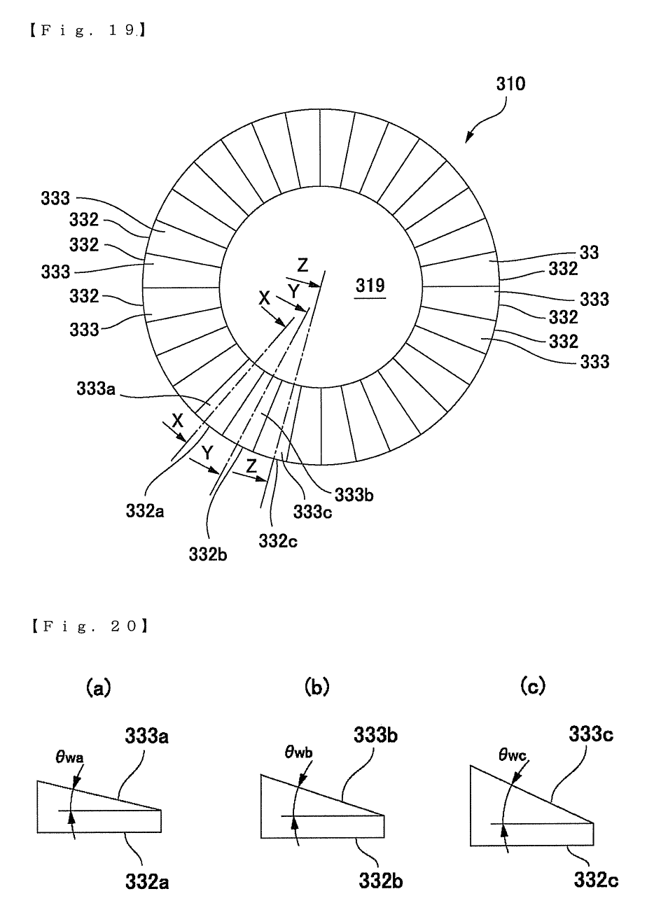

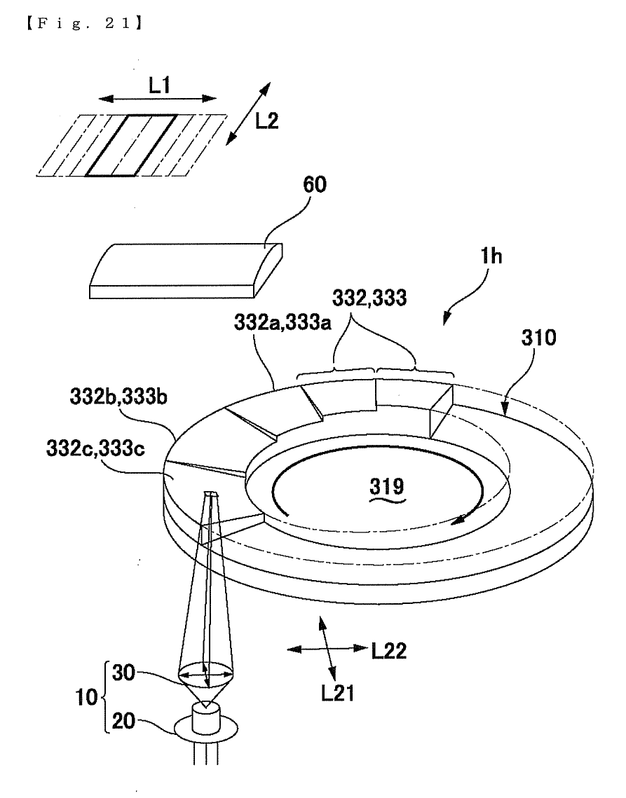

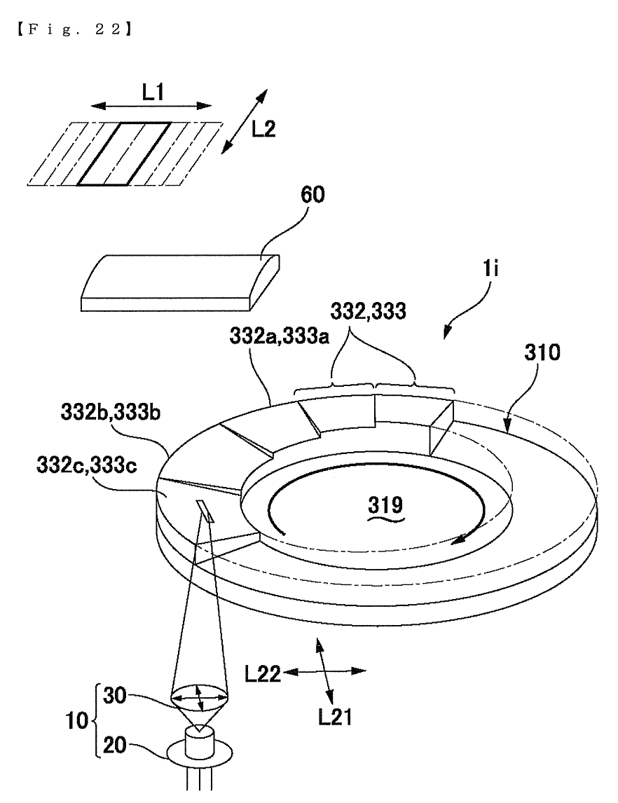

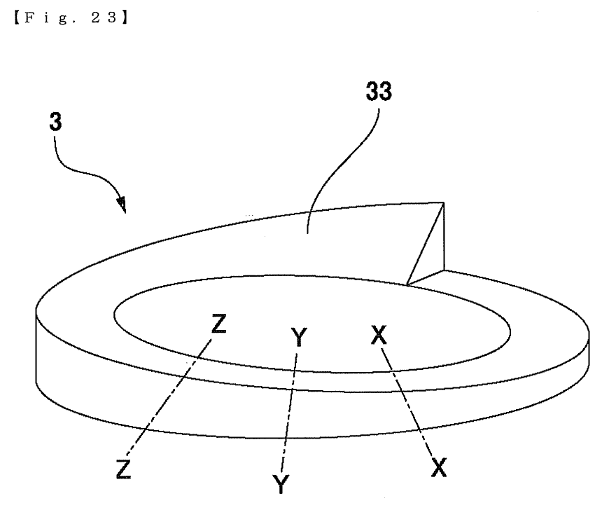

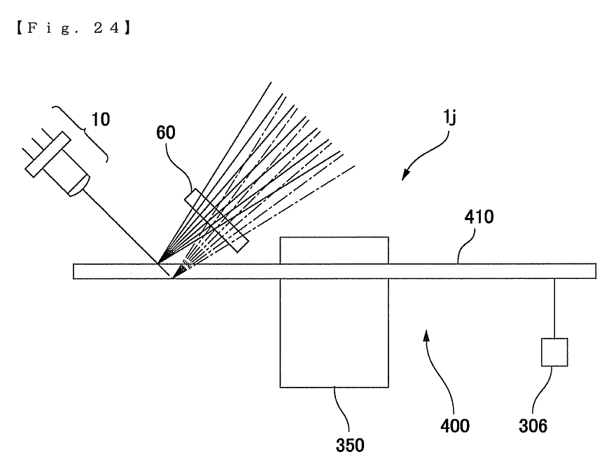

Embodiments will now be described, by way of example only, with reference to the accompanying drawings which are meant to be exemplary, not limiting, and wherein like elements are numbered alike in several Figures, in which:

[FIGS. 1] (a) and (b) are an explanatory views showing an optical structure in a scanning direction of a light beam of a light beam scanning device in accordance with a first embodiment of the present invention and an explanatory view showing an optical structure in a direction perpendicular to the scanning direction.

[FIG. 2] is an explanatory view showing a state where a light beam emitted from a light source device is irradiated to a polygon mirror in the light beam scanning device in accordance with the first embodiment of the present invention.

[FIG. 3] is an explanatory view showing a directional relationship between a convergent direction of the light beam and the polygon mirror in the light beam scanning device in accordance with the first embodiment of the present invention.

[FIGS. 4] (a) and (b) are an explanatory views showing an optical structure in a scanning direction of a light beam of a light beam scanning device in accordance with a second embodiment of the present invention and an explanatory view showing an optical structure in a direction perpendicular to the scanning direction.

[FIG. 5] is an explanatory view showing a directional relationship between a convergent direction of the light beam and a polygon mirror in the light beam scanning device in accordance with the second embodiment of the present invention.

[FIGS. 6] (a) and (b) are an explanatory views showing an optical structure in a scanning direction of a light beam of a light beam scanning device in accordance with a third embodiment of the present invention and an explanatory view showing an optical structure in a direction perpendicular to the scanning direction.

[FIG. 7] an explanatory view showing a directional relationship between a convergent direction of the light beam and a polygon mirror in the light beam scanning device in accordance with the third embodiment of the present invention.

[FIG. 8] is a perspective view showing a schematic structure of a light beam scanning device in accordance with a fourth embodiment of the present invention.

[FIG. 9] is a schematic side view schematically showing a schematic structure of the light beam scanning device shown in FIG. 8.

[FIG. 10] is a schematic perspective view schematically showing a state where a light beam is scanned in the light beam scanning device shown in FIG. 8.

[FIG. 11] is a top plan view showing a transmission type optical deflection disk which is used in the light beam scanning device shown in FIG. 8.

[FIG. 12] is a cross-sectional view showing “W-W” cross section of the transmission type optical deflection disk shown in FIG. 11.

[FIG. 13] is a schematic perspective view schematically showing a state where a light beam is scanned in a light beam scanning device in accordance with a fifth embodiment of the present invention.

[FIG. 14] is a schematic perspective view schematically showing a state where a light beam is scanned in a light beam scanning device in accordance with a sixth embodiment of the present invention.

[FIG. 15] is a perspective view schematically showing a schematic structure of a refractive optical element which is used in a light beam scanning device in accordance with a seventh embodiment of the present invention.

[FIG. 16] is a perspective view showing a schematic structure of a light beam scanning device in accordance with an eighth embodiment of the present invention.

[FIG. 17] is a schematic side view schematically showing a schematic structure of the light beam scanning device shown in FIG. 16.

[FIG. 18] is a schematic perspective view schematically showing a state where a light beam is scanned in the light beam scanning device shown in FIG. 16.

[FIG. 19] is a top plan view showing a transmission type optical deflection disk which is used in the light beam scanning device in accordance with the eighth embodiment of the present invention.

[FIGS. 20] (a), (b) and (c) are respectively cross-sectional views showing the transmission type optical deflection disk shown in FIG. 19, i.e., a cross-sectional view of “X-X” cross section, a cross-sectional view of “Y-Y” cross section and a cross-sectional view of “Z-Z” cross section.

[FIG. 21] is a schematic perspective view schematically showing a state where a light beam is scanned in a light beam scanning device in accordance with a ninth embodiment of the present invention.

[FIG. 22] is a schematic perspective view schematically showing a state where a light beam is scanned in a light beam scanning device in accordance with a tenth embodiment of the present invention.

[FIG. 23] is a perspective view schematically showing a schematic structure of a refractive optical element which is used in a light beam scanning device in accordance with a eleventh embodiment of the present invention.

[FIG. 24] is a schematic side view schematically showing a schematic structure of a light beam scanning device in accordance with a twelfth embodiment of the present invention.

### EXPLANATION OF REFERENCE NUMERALS

1a through 1j light beam scanning device
10 light source device
20 light emitting source
30 condenser lens
60 divergence angle modification lens
200, 300, 400 optical deflection mechanism
210 polygon mirror (optical deflection element)
310 transmission type optical deflection disk (optical deflection element)
410 reflection type optical deflection disk (optical deflection element)
L1 scanning direction
L2 direction perpendicular to the scanning direction

### BEST MODE FOR CARRYING OUT THE INVENTION

The best mode for carrying out the present invention will be described below with reference to the accompanying drawings.

### First Embodiment

### (Entire Structure)

FIG. 1 is an explanatory view showing an optical structure of a light beam scanning device in accordance with a first embodiment of the present invention. FIG. 1(a) is an explanatory view in a scanning direction of a light beam and FIG. 1(b) is an explanatory view in a direction perpendicular to the scanning direction. FIG. 2 is an explanatory view showing a state where a light beam emitted from a light source device is irradiated to a polygon mirror in the light beam scanning device in accordance with the first embodiment of the present invention. FIG. 3 is an explanatory view showing a directional relationship between a convergent direction of the light beam and the polygon mirror in the light beam scanning device in accordance with the first embodiment of the present invention. In FIGS. 1(a) and 1(b), a solid line is illustrated in a direction where an optical deflection element exerts a deflection operation and an alternate long and short dash line is illustrated in a direction where the optical deflection element does not exert a deflection operation. Further, a divergence angle modification lens is indicated with a solid line in a direction where the divergence angle modification lens has a power and is indicated with an alternate long and short dash line in a direction where the divergence angle modification lens does not have a power.

As shown in FIG. 1, FIG. 2 and FIG. 3, a light beam scanning device 1a in accordance with this embodiment includes a light source device 10 and an optical deflection mechanism 200 for scanning a light beam, which is emitted from the light source device 10, over a prescribed angular range with an optical deflection element. The light source device 10 is provided with a light emitting source 20 comprised of a laser diode (laser beam emitting element) which emits a laser beam, for example, with a wavelength of 880 nm, and a condenser lens 30 for converging the light beam emitted from the light emitting source 20. The light source device 10 is also provided with a diaphragm member (not shown).

In this embodiment, an aspherical lens or the like having a positive power can be used as the condenser lens 30. The condenser lens 30 guides as a converged light beam focusing at an optical deflection element described below or at its vicinity in the first direction “L11” and guides to the optical deflection element in a state of a divergent beam in the second direction “L12” in which the first direction “L11” and the second direction “L12” are perpendicular to the optical axis direction.

In this embodiment, a light beam emitted from the light emitting source 20 is focused through the condenser lens 30 in a direction where its divergence angle is larger. However, it may be structured that a light beam emitted from the light emitting source 20 is focused through the condenser lens 30 in a direction where its divergence angle is smaller.

In this embodiment, the optical deflection mechanism 200 includes a polygon mirror 210 as an optical deflection element and a drive mechanism comprised of a motor (not shown) for rotating the polygon mirror 210 around an axial line “L210”. The light beam which is emitted from the light source device 10 is scanned over a prescribed angular range in the first direction “L11” and is not scanned in the second direction “L12”.

Further, in the light beam scanning device 1a in this embodiment, a divergence angle modification lens 60 is disposed for an emitted light beam from the optical deflection mechanism 200. The divergence angle modification lens 60 is a cylindrical lens which has a positive power only in the direction “L2” perpendicular to the scanning direction “L1” by the optical deflection mechanism 200 and which does not have a power in the scanning direction “L1”.

(Operation and Effects in this Embodiment)

In the light beam scanning device 1a structured as described above, a light beam which is emitted from the light source device 10 is irradiated on the reflection face 211 of the polygon mirror 210 and is scanned in a prescribed angular range in the scanning direction “L1” by the polygon mirror 210 as a light beam having a prescribed divergence angle.

In this embodiment, the light beam which is emitted from the light source device 10 is focused on the reflection face 211 or its vicinity of the polygon mirror 210 in the first direction “L11” (direction which is perpendicular to the axial line “L210” (rotating center axial line) of the polygon mirror 210). However, the light beam reaches to the reflection face 211 of the polygon mirror 210 in a divergent beam state in the second direction “L12” (direction which is parallel to the axial line “L210” (rotating center axial line) of the polygon mirror 210). Therefore, the light beam which is emitted from the light source device 10 forms a longitudinally long spot on the reflection face 211 of the polygon mirror 210. Accordingly, a transversal width of a spot formed on the reflection face 211 is narrow in comparison with the prior art and thus the polygon mirror 210 whose outside dimension is small can be used.

Moreover, since a laser beam emitting element is used as the light emitting source 20, an incident light beam to the polygon mirror 210 can be made small. Therefore, a size of an optical system can be reduced.

Further, in the light beam scanning device 1a in this embodiment, a distance between the light emitting source 20 and the condenser lens 30 and a distance between the condenser lens 30 and the polygon mirror 210 are set so that the light beam emitted from the light source device 10 is focused on the reflection face 211 or its vicinity of the polygon mirror 210 in the first direction “L11”. Therefore, in the second direction “L12” (the direction “L2” which is perpendicular to the scanning direction “L1”), there is a restriction that a divergence angle of the light beam emitted from the polygon mirror 210 cannot be set at a desired angle. However, in this embodiment, the divergence angle modification lens 60 sets a divergence angle of the light beam emitted from the polygon mirror 210 at a desired angle in the direction “L2” (the second direction) which is perpendicular to the scanning direction “L1” by the polygon mirror 210. Therefore, according to the light beam scanning device 1a in this embodiment, a light beam can be scanned whose divergence angle in the direction “L2” which is perpendicular to the scanning direction “L1” is in a prescribed condition. As a result, when the light beam scanning device 1a is used as an inter-vehicle distance measuring device or a monitoring device, a light beam having a divergence angle which is prescribed by the divergence angle modification lens 60 can be scanned over an angular range prescribed by the polygon mirror 210.

In addition, the divergence angle modification lens 60 has a power only in the direction “L2” which is perpendicular to the scanning direction “L1” and thus designing of the optical deflection mechanism 200 is easy. Further, even in a case that environmental temperature is varied to vary optical characteristics of the divergence angle modification lens 60, when the divergence angle modification lens 60 does not act on the scanning direction, a stable scanning can be performed.

### Second Embodiment

FIG. 4 is an explanatory view showing an optical structure of a light beam scanning device in accordance with a second embodiment of the present invention. FIG. 4(a) is an explanatory view in a scanning direction of a light beam and FIG. 4(b) is an explanatory view in a direction perpendicular to the scanning direction. FIG. 5 is an explanatory view showing a directional relationship between a convergent direction of the light beam and a polygon mirror in the light beam scanning device in accordance with the second embodiment of the present invention. A basic structure of the light beam scanning device in this embodiment is similar to that in the first embodiment and thus the same notational symbols are used for common portions and their detailed descriptions are omitted. Further, in FIGS. 4(a) and (b), similarly to FIGS. 1(a) and 1(b), a solid line is illustrated in a direction where an optical deflection element exerts a deflection operation and an alternate long and short dash line is illustrated in a direction where the optical deflection element does not exert a deflection operation. Further, a divergence angle modification lens is indicated with a solid line in a direction where the divergence angle modification lens has a power and is indicated with an alternate long and short dash line in a direction where the divergence angle modification lens does not have a power.

As shown in FIG. 4 and FIG. 5, a light beam scanning device 1b (shown in FIG. 5) in this embodiment includes, similarly to the first embodiment, a light source device 10 and an optical deflection mechanism 200 for scanning a light beam which is emitted from the light source device 10 over a prescribed angular range with an optical deflection element. The light source device 10 is provided with a light emitting source 20 comprised of a laser beam emitting element and the like and a condenser lens 30 for converging the light beam emitted from the light emitting source 20.

In this embodiment, an aspherical lens or the like having a positive power can be used as the condenser lens 30. The condenser lens 30 guides the light beam emitted from the light emitting source 20 as a converged light beam which is focused on an optical deflection element or its vicinity both in the first direction “L11” and the second direction “L12” that are perpendicular to an optical axis direction.

Also in this embodiment, the optical deflection mechanism 200 includes, similarly to the first embodiment, a polygon mirror 210 as an optical deflection element and a drive mechanism comprised of a motor (not shown) for rotating the polygon mirror 210 around an axial line “L210”. The light beam which is emitted from the light source device 10 is scanned over a prescribed angular range in the first direction “L11” and is not scanned in the second direction “L12”.

Further, also in the light beam scanning device 1b in this embodiment, similarly to the first embodiment, a divergence angle modification lens 60 is disposed for an emitted light beam from the optical deflection mechanism 200. The divergence angle modification lens 60 is a cylindrical lens which has a positive power only in the direction “L2” perpendicular to the scanning direction “L1” by the optical deflection mechanism 200 and which does not have a power in the scanning direction “L1”.

In the light beam scanning device 1b structured as described above, a light beam which is emitted from the light source device 10 is irradiated on the reflection face 211 of the polygon mirror 210 and is scanned in a direction shown by the arrow “L1” as a light beam having a prescribed radiation angle.

In this embodiment, the light beam emitted from the light source device 10 is focused on the reflection face 211 or its vicinity of the polygon mirror 210 both in the first direction “L1” and the second direction “L2”. Therefore, the light beam emitted from the light source device 10 forms a small spot on the reflection face 211 of the polygon mirror 210. Accordingly, a size of a spot formed on the reflection face 211 is narrow both in the longitudinal direction and the transversal direction in comparison with the prior art and thus a thin-type polygon mirror 210 having a small outside dimension can be used.

Further, in the light beam scanning device 1b in this embodiment, a distance between the light emitting source 20 and the condenser lens 30 and a distance between the condenser lens 30 and the polygon mirror 210 are set so that the light beam emitted from the light source device 10 is focused on the reflection face 211 or its vicinity of the polygon mirror 210 both in the first direction “L11” and the second direction “L12”. Therefore, in the second direction “L12”, there is a restriction that a divergence angle of the light beam emitted from the polygon mirror 210 cannot be set at a desired angle. However, the divergence angle modification lens 60 sets a divergence angle of the light beam emitted from the polygon mirror 210 at a desired angle in the direction “L2” (the second direction “L12”) which is perpendicular to the scanning direction “L1” by the polygon mirror 210. Therefore, according to the light beam scanning device 1b in this embodiment, a light beam can be scanned whose divergence angle in the direction “L2” which is perpendicular to the scanning direction “L1” is in a prescribed condition.

### Third Embodiment

FIG. 6 is an explanatory view showing an optical structure of a light beam scanning device in accordance with a third embodiment of the present invention. FIG. 6(a) is an explanatory view in a scanning direction of a light beam and FIG. 6(b) is an explanatory view in a direction perpendicular to the scanning direction. FIG. 7 is an explanatory view showing a directional relationship between a convergent direction of the light beam and a polygon mirror in the light beam scanning device in accordance with the third embodiment of the present invention. A basic structure of the light beam scanning device in this embodiment is similar to that in the first embodiment and thus the same notational symbols are used for common portions and their detailed descriptions are omitted. Further, in FIGS. 6(a) and 6(b), similarly to FIGS. 1(a) and 1(b), a solid line is illustrated in a direction where an optical deflection element exerts a deflection operation and an alternate long and short dash line is illustrated in a direction where the optical deflection element does not exert a deflection operation. Further, a divergence angle modification lens is indicated with a solid line in a direction having a power and is indicated with an alternate long and short dash line in a direction having no power.

As shown in FIG. 6 and FIG. 7, a light beam scanning device 1c (shown in FIG. 7) in this embodiment includes, similarly to the first embodiment, a light source device 10 and an optical deflection mechanism 200 for scanning a light beam which is emitted from the light source device 10 over a prescribed angular range with an optical deflection element. The light source device 10 is provided with a light emitting source 20 comprised of a laser beam emitting element or the like and a condenser lens 30 for converging the light beam emitted from the light emitting source 20.

In this embodiment, an aspherical lens having a positive power or the like can be used as the condenser lens 30. The condenser lens 30 guides as a converged light beam focusing on an optical deflection element or its vicinity in the second direction “L12” and guides to the optical deflection element in a divergent beam state in the first direction “L11” in which the first direction “L11” and the second direction “L12” are perpendicular to the optical axis direction.

In this embodiment, the optical deflection mechanism 200 includes, similarly to the first embodiment, a polygon mirror 210 as an optical deflection element and a drive mechanism comprised of a motor (not shown) for rotating the polygon mirror 210 around an axial line “L210”. The light beam which is emitted from the light source device 10 is scanned over a prescribed angular range in the first direction “L11” and is not scanned in the second direction “L12”.

Further, also in the light beam scanning device 1c in this embodiment, similarly to the first embodiment, a divergence angle modification lens 60 is disposed for an emitted light beam from the optical deflection mechanism 200. The divergence angle modification lens 60 is a cylindrical lens which has a positive power only in the direction “L2” perpendicular to the scanning direction “L1” by the optical deflection mechanism 200 and which does not have a power in the scanning direction “L1”.

In the light beam scanning device 1c structured as described above, a light beam emitted from the light source device 10 is irradiated on the reflection face 211 of the polygon mirror 210 and is scanned in a direction shown by the arrow “L1” as a light beam of a divergent beam having a prescribed radiation angle.

In this embodiment, the light beam emitted from the light source device 10 is focused on the reflection face 211 or its vicinity of the polygon mirror 210 in the second direction “L12” (direction which is parallel to the axial line “L210” (rotating center axial line) of the polygon mirror 210). However, the light beam reaches to the reflection face 211 of the polygon mirror 210 in a divergent beam state in the first direction “L11”. Therefore, the light beam emitted from the light source device 10 forms a transversally long spot on the reflection face 211 of the polygon mirror 210. Accordingly, a longitudinal width of a spot formed on the reflection face 211 is narrow in comparison with the prior art and thus a thin-type polygon mirror 210 can be used.

Further, in the light beam scanning device 1c in this embodiment, a distance between the light emitting source 20 and the condenser lens 30 and a distance between the condenser lens 30 and the polygon mirror 210 are set so that the light beam emitted from the light source device 10 is focused on the reflection face 211 or its vicinity of the polygon mirror 210 in the second direction “L12”. Therefore, in the second direction “L12” (the direction “L2” perpendicular to the scanning direction “L1”), there is a restriction that a divergence angle of the light beam emitted from the polygon mirror 210 cannot be set at a desired angle. However, the divergence angle modification lens 60 sets a divergence angle of the light beam emitted from the polygon mirror 210 at a desired angle in the direction “L2” (the second direction “L12”) which is perpendicular to the scanning direction “L1” by the polygon mirror 210. Therefore, according to the light beam scanning device 1b in this embodiment, a light beam can be scanned whose divergence angle in the direction “L2” which is perpendicular to the scanning direction “L1” is in a prescribed condition.

### Fourth Embodiment

### (Entire Structure)

FIG. 8 is a perspective view showing a schematic structure of a light beam scanning device in accordance with a fourth embodiment of the present invention. FIG. 9 is a schematic side view schematically showing a schematic structure of the light beam scanning device shown in FIG. 8. FIG. 10 is a schematic perspective view schematically showing a state where a light beam is scanned in the light beam scanning device shown in FIG. 8. FIG. 11 is a top plan view showing a transmission type optical deflection disk which is used in the light beam scanning device shown in FIG. 8. FIG. 12 is a cross-sectional view showing “W-W” cross section of the transmission type optical deflection disk shown in FIG. 11. A basic structure of the light beam scanning device in this embodiment is similar to that in the first embodiment and thus the same notational symbols are used for common portions and their detailed descriptions are omitted.

A light beam scanning device 1d shown in FIG. 8, FIG. 9 and FIG. 10 includes a light source device 10 and an optical deflection mechanism 300 for scanning a light beam which is emitted from the light source device 10 over a prescribed angular range with an optical deflection element. The light source device 10 is provided with a light emitting source 20 comprised of a laser diode (laser beam emitting element) or the like and a condenser lens 30 for converging the light beam emitted from the light emitting source 20. The light source device 10 is also provided with a diaphragm member (not shown).

In this embodiment, the optical deflection mechanism 300 includes a transmission type optical deflection disk 310 as an optical deflection element and a drive mechanism comprised of a motor 350 for rotating the transmission type optical deflection disk 310 around an axial line. The motor 350 is a brushless motor rotatable at a high speed and is structured to be capable of rotating at a speed of, for example, about 10,000 (rpm). A center hole 319 of the transmission type optical deflection disk 310 is fixed to a rotor of the drive motor 350 and the transmission type optical deflection disk 310 can be rotationally driven around a shaft (center of the transmission type optical deflection disk 310) of the drive motor 350. A detailed structure of the transmission type optical deflection disk 310 will be described below. In this embodiment, the drive motor 350 is not limited to a brushless motor. Various motors such as a stepping motor may be applied.

Further, the light beam scanning device 1d is provided with a mirror 305 for directing a light beam emitted from the light source device 10 to the transmission type optical deflection disk 310 and an optical type encoder 306 as a position detecting means for detecting a rotational position of the transmission type optical deflection disk 310. A light beam is emitted from the light source device 10 to a direction parallel to a face which is perpendicular to the shaft of the drive motor 350, in other words, parallel to a disk face of the transmission type optical deflection disk 310. The mirror 305 is a total reflection mirror and is disposed so that the light beam emitted from the light source device 10 is directed to a shaft direction of the drive motor 350 and is incident in a substantially perpendicular direction to the disk face of the transmission type optical deflection disk 310. The drive motor 350, the mirror 305 and the optical type encoder 306 are directly disposed on a frame 308 and the light source device 10 is disposed on the frame 308 through a holder 309. The optical type encoder 306 is disposed so as to face the transmission type optical deflection disk 310 in the shaft direction of the drive motor 350. A lattice not shown is formed on an opposite face of the transmission type optical deflection disk 310 which faces the optical type encoder 306, and the optical type encoder 306 detects the lattice to detect a rotational position of the transmission type optical deflection disk 310. In the light beam scanning device 1d in this embodiment, a rotational operation of the drive motor 350 and an emitting operation of the laser diode which is a light emitting source of the light source device 10 are controlled on the basis of a detection result of the optical type encoder 306. In this embodiment, instead of using the optical type encoder 306, a photo-coupler or a magnetic sensor may be used to detect an angular position of the transmission type optical deflection disk 310. Further, instead of using the mirror 305, a light beam emitted from the light source device 10 may be directly guided to the transmission type optical deflection disk 310.

In this embodiment, the condenser lens 30 of the light source device 10 is, similarly to the first embodiment, an aspherical lens having a positive power or the like. The condenser lens 30 guides the light beam emitted from the light emitting source 20 as a converged light beam which is focused on an upper face or its vicinity of the transmission type optical deflection disk 310 in a first direction “L11” (circumferential direction) and, in addition, guides to the transmission type optical deflection disk 310 as a divergent beam in a second direction “L12” (radial direction) in which the first direction “L11” and the second direction “L12” are perpendicular to the optical axis direction.

In the transmission type optical deflection disk 310, the light beam emitted from the light source device 10 is scanned over a prescribed angular range in the first direction “L11” and is not scanned in the second direction “L12”, which will be described below in detail.

Further, also in the light beam scanning device 1d in this embodiment, similarly to the first embodiment, a divergence angle modification lens 60 is disposed for an emitted light beam from the optical deflection mechanism 300. The divergence angle modification lens 60 is a cylindrical lens which has a positive power only in the direction “L2” perpendicular to the scanning direction “L1” scanned by the optical deflection mechanism 300 and which does not have a power in the scanning direction “L1”.

As shown in FIG. 11 and FIG. 12, a disk face of the transmission type optical deflection disk 310 is divided into a plurality of radial optical deflection regions 332. Each of the plurality of the optical deflection regions 332 is formed with an inclined face 333 which is inclined to a circumferential direction at a constant angle. The inclined face 333 is formed only on an emitting side face of the transmission type optical deflection disk 310.

Each of the inclined faces 333 of the plurality of the optical deflection regions 332 is inclined to the circumferential direction and a cross section of the respective optical deflection regions 332 is formed in a wedge shape. Therefore, the cross section of the respective optical deflection regions 332 is formed in a trapezoid shape whose adjacent faces to adjacent optical deflection regions 332 are parallel to each other. Further, inclination angles of the inclined faces 333 of the plurality of optical deflection regions 332 which are arranged in the circumferential direction are successively varied. An inclination angle of 0 (zero)° may be included in the plurality of the inclined faces 333.

In the transmission type optical deflection disk 310 which is structured as described above, a light beam which is incident on an under side disk face transmits through the transmission type optical deflection disk 310 to be emitted from an upper side disk face. In this case, since the transmission type optical deflection disk 310 is rotated by the drive motor 350, an incident position to the transmission type optical deflection disk 310 is moved. Therefore, an emitting direction of the light beam which is incident on the transmission type optical deflection disk 310 is varied according to the position of the optical deflection regions 332 from which the light beam is emitted. In other words, when an inclination angle of the inclined face 333 is set to be “θw”, a scanning angle of a light beam emitted from the transmission type optical deflection disk 310 is set to be “θs”, and a refractive index of the transmission type optical deflection disk 310 is set to be “n”, the inclined face 333 is formed so as to satisfy the following relationship:

sin(θ w+θ s)=n·sin θ w

Therefore, the light beam which is incident on the transmission type optical deflection disk 310 is scanned over a prescribed angular range. In this embodiment, “n” is a refractive index of material structuring the transmission type optical deflection disk 310. For example, in a case that “n”=1.51862, in order to set that the scanning angle “θs” is 10°, the inclination angle “θw” is set to be 18.02°. Further, the number of the optical deflection regions 332 is determined by a number of scanning points of scanning of the light beam. In this embodiment, 201 pieces of the optical deflection regions 332 are formed. Therefore, for example, when a scanning area of the light beam is set to be ±10°, a resolving power of scanning of the light beam becomes 0.1°. Further, for example, when a diameter of the transmission type optical deflection disk 310 at a transmitting position of a light beam is set to be 40 mm, a width in the circumferential direction of one optical deflection region 332 at the transmitting position of the light beam becomes 0.63 mm. In FIG. 10 and FIG. 11, the number of the optical deflection regions 332 is reduced to be illustrated for convenience of explanation. Further, it is preferable that the inclination angle “θw” of the inclined face 333 is set so as to gradually decrease from a positive inclination angle to a negative inclination angle in the circumferential direction and then the inclination angle gradually decreases and, when turned once, the inclination angle returns to the positive inclination angle. Alternatively, the inclined face 333 may be formed so as to gradually decrease from a positive inclination angle to a negative inclination angle and then, on the contrary, to gradually increase from the negative inclination angle to the positive inclination angle, and the positive inclination angle and the negative inclination angle are repeated in the circumferential direction. In accordance with an embodiment, an antireflection processing may be applied to the transmission type optical deflection disk 310 by using a thin film, a fine structure or the like.

The transmission type optical deflection disk 310 having a structure as described above may be manufactured by directly applying an ultra-precision processing such as cutting to transparent resin or may be manufactured by using a molding die in consideration of manufacturing cost. When the transmission type optical deflection disk 310 or a molding die is manufactured by cutting work, it may be structured that a direction where a blade edge used in cutting work is advanced is set in a radial direction of the transmission type optical deflection disk 310 to form one inclined face 333 and then, while changing an inclined direction of the blade edge, the transmission type optical deflection disk 310 is turned by a prescribed angle in the circumferential direction to form an inclined face 333 of an adjacent optical deflection region 332.

(Operation and Effects in this Embodiment)

In the light beam scanning device 1d structured as described above, a light beam emitted from the light source device 10 is incident on the transmission type optical deflection disk 310 in a state that the transmission type optical deflection disk 310 is rotated. As a result, the light beam is incident on a prescribed position in the circumferential direction of the transmission type optical deflection disk 310 to be transmitted through and emitted from the upper side disk face. At this time, the light beam is emitted to a direction corresponding to the inclination angle of the inclined face 333 of the optical deflection region 332 and is scanned over a prescribed angular range in the scanning direction “L1” as a light beam having a prescribed divergence angle. In this case, the light beam is incident on a center position in the circumferential direction of one optical deflection region 332. An effective diameter of the light beam which is incident on the transmission type optical deflection disk 310 is preferably equal to or less than a width dimension in the circumferential direction of one optical deflection region 332. When the above-mentioned scanning is performed, rotation of the drive motor 350 and emitting timing of the light emitting source are controlled on the basis of a detection result of the optical type encoder 306 so that the laser beam emitted from the light source device 10 is incident at the center position in the circumferential direction of one optical deflection region 332.

In this embodiment, the light beam emitted from the light source device 10 is focused on an upper face or its vicinity of the transmission type optical deflection disk 310 in the first direction “L11” and, on the other hand, is reached to the upper face of the transmission type optical deflection disk 310 in a state of a divergent beam in the second direction “L12”. Therefore, the light beam emitted from the light source device 10 forms a radially extended spot on the upper face of the transmission type optical deflection disk 310. Accordingly, a width of the optical deflection region 332 which is formed in the transmission type optical deflection disk 310 may be narrow. As a result, a number of optical deflection regions 332 can be formed even in a small transmission type optical deflection disk 310 and thus a high degree of resolution can be obtained.

In addition, since a laser beam emitting element is used as the light emitting source 20, a light beam incident on the transmission type optical deflection disk 310 can be small. Therefore, a size of the optical system can be reduced.

Further, in the light beam scanning device 1d in this embodiment, a distance between the light emitting source 20 and the condenser lens 30 and a distance between the condenser lens 30 and the transmission type optical deflection disk 310 are set so that the light beam emitted from the light source device 10 is focused on the upper face or its vicinity of the transmission type optical deflection disk 310 in the first direction “L11”. Therefore, there is a restriction that a divergence angle of the light beam emitted from the transmission type optical deflection disk 310 cannot be set at a desired angle in the second direction “L12”. However, in this embodiment, the divergence angle modification lens 60 is disposed on a rear side of the transmission type optical deflection disk 310, and the divergence angle modification lens 60 sets a divergence angle of the light beam emitted from the transmission type optical deflection disk 310 at a desired angle in the direction “L2” (the second direction “L12”) which is perpendicular to the scanning direction “L1” of the transmission type optical deflection disk 310. Therefore, according to the light beam scanning device 1d in this embodiment, a light beam can be scanned whose divergence angle in the direction “L2” which is perpendicular to the scanning direction “L1” is in a prescribed condition. As a result, when the light beam scanning device 1d is used as an inter-vehicle distance measuring device or a monitoring device, a light beam having a divergence angle which is prescribed by the divergence angle modification lens 60 can be scanned over an angular range prescribed by the transmission type optical deflection disk 310.

In addition, the divergence angle modification lens 60 has a power only in the direction “L2” which is perpendicular to the scanning direction “L1” and thus designing of the optical deflection mechanism 200 is easy. Further, even in a case that environmental temperature varies to vary optical characteristics of the divergence angle modification lens 60, when the divergence angle modification lens 60 does not act on the scanning direction, a stable scanning can be performed.

Further, in the light beam scanning device 1d in this embodiment, the transmission type optical deflection disk 310 is in a flat disk shape and thus the device can be made thinner. In addition, it is structured that the light beam emitted from the light source device 10 is transmitted through the transmission type optical deflection disk 310. Therefore, even when rotational wobbling and surface wobbling are occurred in the transmission type optical deflection disk 310 which is rotated by the drive motor 350, the refraction angle is hardly varied. Therefore, scanning jitter of the light beam is satisfactory. In addition, since the transmission type optical deflection disk 310 is formed of resin, productivity of the transmission type optical deflection disk 310 is high and weight and cost of the light beam scanning device 1d can be reduced. Moreover, even when temperature varies, for example, about ±50 degree Celsius, the variation rate of the scanning angle is equal to or less than 1% and thus there is little influence on the scanning performance.

### Fifth Embodiment

FIG. 13 is a schematic perspective view schematically showing a state where a light beam is scanned in a light beam scanning device in accordance with a fifth embodiment of the present invention. A basic structure of the light beam scanning device in this embodiment is similar to that in the fourth embodiment and thus the same notational symbols are used for common portions and their detailed descriptions are omitted.

As shown in FIG. 13, in the light beam scanning device 1e in this embodiment, a condenser lens 30 in the light source device 10 guides a light beam emitted from the light emitting source 20 as a converged light beam which is focused on an upper face or its vicinity of the transmission type optical deflection disk 310 both in the first direction “L11” and the second direction “L12” in which the first direction “L11” and the second direction “L12” are perpendicular to an optical axis direction.

Further, a disk face of the transmission type optical deflection disk 310 is divided into a plurality of radial optical deflection regions 332. Each of the plurality of the optical deflection regions 332 is formed with an inclined face 333 which is inclined to a circumferential direction at a constant angle.

Further, also in the light beam scanning device 1e in this embodiment, similarly to the fourth embodiment, a divergence angle modification lens 60 is disposed for an emitted light beam from the optical deflection mechanism 300. The divergence angle modification lens 60 is a cylindrical lens which has a positive power only in the direction “L2” perpendicular to the scanning direction “L1” by the optical deflection mechanism 300 and which does not have a power in the scanning direction “L1”.

In the light beam scanning device 1e structured as described above, the light beam emitted from the light source device 10 is focused on the upper face or its vicinity of the transmission type optical deflection disk 310 both in the first direction “L11” and the second direction “L12”. Therefore, the light beam emitted from the light source device 10 forms a small spot on the upper face of the transmission type optical deflection disk 310. Accordingly, a width of the optical deflection region 332 formed in the transmission type optical deflection disk 310 may be narrow. Further, a diameter of the transmission type optical deflection disk 310 may be smaller. Therefore, according to this embodiment, even in a small transmission type optical deflection disk 310, a large number of optical deflection regions 332 can be formed and thus a high degree of resolution can be obtained.

Further, in the light beam scanning device 1e in this embodiment, a distance between the light emitting source 20 and the condenser lens 30 and a distance between the condenser lens 30 and the transmission type optical deflection disk 310 are set so that the light beam emitted from the light source device 10 is focused on the upper face or its vicinity of the transmission type optical deflection disk 310 both in the first direction “L11” and the second direction “L12”. Therefore, in the second direction “L12”, there is a restriction that a divergence angle of the light beam emitted from the transmission type optical deflection disk 310 cannot be set at a desired angle. However, the divergence angle modification lens 60 sets a divergence angle of the light beam emitted from the transmission type optical deflection disk 310 at a desired angle in the direction “L2” (the second direction “L12”) which is perpendicular to the scanning direction “L1” by the transmission type optical deflection disk 310. Therefore, according to the light beam scanning device 1e in this embodiment, a light beam can be scanned whose divergence angle in the direction “L2” which is perpendicular to the scanning direction “L1” is in a prescribed condition.

### Sixth Embodiment

FIG. 14 is a schematic perspective view schematically showing a state where a light beam is scanned in a light beam scanning device in accordance with a sixth embodiment of the present invention. A basic structure of the light beam scanning device in this embodiment is similar to that in the fourth embodiment and thus the same notational symbols are used for common portions and their detailed descriptions are omitted.

As shown in FIG. 14, in the light beam scanning device 1f in this embodiment, a condenser lens 30 in the light source device 10 guides a light beam emitted from the light emitting source 20 as a converged light beam which is focused on an upper face or its vicinity of the transmission type optical deflection disk 310 in the second direction “L12” and guides to the upper face of the transmission type optical deflection disk 310 as a divergent beam in the first direction “L11” in which the first direction “L11” and the second direction “L12” are perpendicular to an optical axis direction.

Further, a disk face of the transmission type optical deflection disk 310 is divided into a plurality of radial optical deflection regions 332 and each of the plurality of the optical deflection regions 332 is formed with an inclined face 333 which is inclined in a circumferential direction at a constant angle.

Further, also in the light beam scanning device 1f in this embodiment, similarly to the fourth embodiment, a divergence angle modification lens 60 is disposed for an emitted light beam from the optical deflection mechanism 300. The divergence angle modification lens 60 is a cylindrical lens which has a positive power only in the direction “L2” perpendicular to the scanning direction “L1” by the optical deflection mechanism 300 and which does not have a power in the scanning direction “L1”.

In the light beam scanning device 1f structured as described above, the light beam emitted from the light source device 10 is focused on an upper face or its vicinity of the transmission type optical deflection disk 310 in the second direction “L12” and, on the other hand, is reached to the upper face of the transmission type optical deflection disk 310 in a state of a divergent beam in the first direction “L11”. Therefore, the light beam emitted from the light source device 10 forms a spot extended in the circumferential direction on the upper face of the transmission type optical deflection disk 310. Accordingly, a diameter of the transmission type optical deflection disk 310 may be small.

Further, in the light beam scanning device 1f in this embodiment, a distance between the light emitting source 20 and the condenser lens 30 and a distance between the condenser lens 30 and the transmission type optical deflection disk 310 are set so that the light beam emitted from the light source device 10 is focused on the upper face or its vicinity of the transmission type optical deflection disk 310 in the second direction “L12”. Therefore, there is a restriction that a divergence angle of the light beam emitted from the transmission type optical deflection disk 310 cannot be set at a desired angle in the second direction “L12”. However, in this embodiment, the divergence angle modification lens 60 sets a divergence angle of the light beam emitted from the transmission type optical deflection disk 310 at a desired angle in the direction “L2” (the second direction) which is perpendicular to the scanning direction “L1” scanned by the transmission type optical deflection disk 310. Therefore, according to the light beam scanning device 1f in this embodiment, a light beam can be scanned whose divergence angle in the direction “L2” which is perpendicular to the scanning direction “L1” is in a prescribed condition. As a result, when the light beam scanning device 1f is used as an inter-vehicle distance measuring device or a monitoring device, a light beam having a divergence angle which is prescribed by the divergence angle modification lens 60 can be scanned over an angular range prescribed by the transmission type optical deflection disk 310.

### Seventh Embodiment

FIG. 15 is a perspective view schematically showing a schematic structure of a refractive optical element which is used in a light beam scanning device in accordance with a seventh embodiment of the present invention. A basic structure of the light beam scanning device and the refractive optical element in this embodiment is similar to those in the fourth, the fifth and the sixth embodiments and thus the same notational symbols are used for common portions and their detailed descriptions are omitted.

In the transmission type optical deflection disk 310 in accordance with the fourth, the fifth and the sixth embodiments, a plurality of optical deflection regions 32 is formed in the circumferential direction and, for each of these optical deflection regions 32, the inclined face 33 is formed in which the inclination angle “θw” is constant for every optical deflection region. In this embodiment, as shown in FIG. 15, a plurality of optical deflection regions 32 is formed in the circumferential direction and each of the optical deflection regions 32 is formed with an inclined face 33 whose inclination angle “θw” in the circumferential direction is continuously varied in the circumferential direction. It may be structured that the shape of the face is expressed as a quadratic function in the tangential direction and an inclination which is expressed by a first order differentiation is continuously varied in the tangential direction. Even in the light beam scanning device in which the transmission type optical deflection disk 310 structured as described above is used, when the light beam incident on the transmission type optical deflection disk 310 is transmitted through the transmission type optical deflection disk 310, the light beam is refracted by the inclined face 33 to be scanned in the tangential direction of the transmission type optical deflection disk 310. FIG. 15 is an example where the inclined face 33 is inclined toward only one side but may be formed in a “U” shape such as a parabola or in a “sine” curve.

### Eighth Embodiment

### (Entire Structure)

FIG. 16 is a perspective view showing a schematic structure of a light beam scanning device in accordance with an eighth embodiment of the present invention. FIG. 17 is a schematic side view schematically showing a schematic structure of the light beam scanning device shown in FIG. 16. FIG. 18 is a schematic perspective view schematically showing a state where a light beam is scanned in the light beam scanning device shown in FIG. 16. FIG. 19 is a top plan view showing a transmission type optical deflection disk which is used in the light beam scanning device in accordance with the eighth embodiment of the present invention. FIG. 20 is a cross-sectional view showing the transmission type optical deflection disk shown in FIG. 19, and (a), (b) and (c) are respectively a cross-sectional view of “X-X” cross section, a cross-sectional view of “Y-Y” cross section and a cross-sectional view of “Z-Z” cross section. A basic structure of the light beam scanning device in this embodiment is similar to that in the fourth embodiment and thus the same notational symbols are used for common portions and their detailed descriptions are omitted.

A light beam scanning device 1g shown in FIG. 16, FIG. 17 and FIG. 18, similarly to the fourth embodiment, includes a light source device 10 and an optical deflection mechanism 300 for scanning a light beam, which is emitted from the light source device 10, over a prescribed angular range by an optical deflection element. The light source device 10 is provided with a light emitting source 20 comprised of a laser diode (laser beam emitting element) or the like and a condenser lens 30 for converging the light beam emitted from the light emitting source 20. The optical deflection mechanism 300 includes, similarly to the fourth embodiment, a transmission type optical deflection disk 310 as an optical deflection element and a drive mechanism comprised of a motor 350 for rotating the transmission type optical deflection disk 310 around an axial line. Further, the light beam scanning device 1g is provided with a mirror 305 for directing a light beam emitted from the light source device 10 to the transmission type optical deflection disk 310 and an optical type encoder 306 as a position detecting means for detecting a rotational position of the transmission type optical deflection disk 310. The drive motor 350, the mirror 305 and the optical type encoder 306 are directly disposed on a frame 308 and the light source device 10 is disposed on the frame 308 through a holder 309.

In this embodiment, the condenser lens 30 of the light source device 10 is, similarly to the first and the fourth embodiments, an aspherical lens having a positive power or the like. The condenser lens 30 guides the light beam emitted from the light emitting source 20 as a converged light beam which is focused on an upper face or its vicinity of the transmission type optical deflection disk 310 in a first direction “L21” (circumferential direction) and, on the other hand, guides to the transmission type optical deflection disk 310 as a divergent beam in a second direction “L22” (radial direction) in which the first direction “L21” and the second direction “L22” are perpendicular to an optical axis direction.

In this embodiment, the transmission type optical deflection disk 310 scans the light beam emitted from the light source device 10 over a prescribed angular range in the second direction “L22” but does not scan in the first direction “L21”, which will be described below in detail.

Further, also in the light beam scanning device 1g in this embodiment, similarly to the first and the fourth embodiments, a divergence angle modification lens 60 is disposed for an emitted light beam from the optical deflection mechanism 300. The divergence angle modification lens 60 is a cylindrical lens which has a positive power only in the direction “L2” perpendicular to the scanning direction “L1” by the optical deflection mechanism 300 and which does not have a power in the scanning direction “L1”.

As shown in FIG. 19 and FIG. 20, a disk face of the transmission type optical deflection disk 310 is divided into a plurality of radial optical deflection regions 332 and each of the plurality of the optical deflection regions 332 is formed with an inclined face 333 which is inclined to a radial direction at a constant angle. In this embodiment, the inclined face 333 is formed only on an emitting side face of the transmission type optical deflection disk 310.

Each of the inclined faces 333 of the plurality of the optical deflection regions 332 is inclined to the radial direction and a cross section of the respective optical deflection regions 332 is formed in a wedge shape. Therefore, the cross section of the respective optical deflection regions 332 is formed in a substantially trapezoid shape whose inner peripheral end and outer peripheral end are substantially parallel to each other. Further, inclination angles of the inclined faces 333 of the plurality of optical deflection regions 332 which are arranged in the circumferential direction are successively varied. An inclination angle of 0 (zero)° may be included in the plurality of the inclined faces 333.

In the transmission type optical deflection disk 310 which is structured as described above, a light beam which is incident on an under side disk face transmits through the transmission type optical deflection disk 310 to be emitted from an upper side disk face. In this case, since the transmission type optical deflection disk 310 is rotated by the drive motor 350, an incident position to the transmission type optical deflection disk 310 is moved. Therefore, an emitting direction of the light beam which is incident on the transmission type optical deflection disk 310 is varied according to the position of the optical deflection regions 332 from which the light beam is emitted. In other words, when an inclination angle of the inclined face 333 is set to be “θw”, a scanning angle of a light beam emitted from the transmission type optical deflection disk 310 is set to be “θs”, and a refractive index of the transmission type optical deflection disk 310 is set to be “n”, the inclined face 333 is formed so as to satisfy the flowing relationship:

sin(θ w+θ s)=n·sin θ w

Therefore, the light beam which is incident on the transmission type optical deflection disk 310 is scanned over a prescribed angular range. In this embodiment, “n” is a refractive index of material structuring the transmission type optical deflection disk 310. For example, in a case that “n”=1.51862, in order to set that the scanning angle “θs” is 10°, the inclination angle “θw” is set to be 18.02°.

Further, the number of the optical deflection regions 332 is determined by a number of scanning points of scanning of the light beam. In this embodiment, 201 pieces of the optical deflection regions 332 are formed. Therefore, for example, when a scanning area of the light beam is set to be ±10°, a resolving power of scanning of the light beam becomes 0.1°. Further, for example, when a diameter of the transmission type optical deflection disk 310 at a transmitting position of a light beam is set to be 40 mm, a width in the circumferential direction of one optical deflection region 332 at the transmitting position of the light beam becomes 0.63 mm. In FIG. 18 and FIG. 19, the number of the optical deflection regions 332 is reduced to illustrate for convenience of explanation. Further, in the adjacent optical deflection regions 332a, 332b and 332c, it is structured that the inclination angles “θwa”, “θwb” and “θwc” of the respective inclined faces 333a, 333b and 333c are gradually increased. However, the inclined faces 333 may be formed so as to incline to an opposite side to the inclination direction shown in FIG. 20. Further, it is preferable that the inclination angle “θw” of the inclined face 333 is set so as to gradually decrease from a positive inclination angle to a negative inclination angle in the circumferential direction and then the inclination angle gradually decreases and, when turned once, the inclination angle returns to the positive inclination angle. However, the inclined face 333 may be formed so as to gradually decrease from a positive inclination angle to a negative inclination angle and then, on the contrary, to gradually increase from the negative inclination angle to the positive inclination angle, and the positive inclination angle and the negative inclination angle are repeated in the circumferential direction. In accordance with an embodiment, an antireflection processing may be applied to the transmission type optical deflection disk 310 with a thin film, a fine structure or the like.

The transmission type optical deflection disk 310 having a structure as described above may be manufactured by directly applying to transparent resin with an ultra-precision processing such as cutting or may be manufactured by using a molding die in consideration of manufacturing cost. When the transmission type optical deflection disk 310 or a molding die is manufactured by cutting work, it may be structured that a direction where a blade edge used for cutting work is advanced is set in a radial direction of the transmission mold optical deflection disk 310 to form one inclined face 333 and then, while changing an inclined direction of the blade edge, the transmission type optical deflection disk 310 is turned by a prescribed angle in the circumferential direction to form an inclined face 333 of an adjacent optical deflection region 332.

(Operation and Effects in this Embodiment)

In the light beam scanning device 1g structured as described above, a light beam emitted from the light source device 10 is incident on the transmission type optical deflection disk 310 in a state that the transmission type optical deflection disk 310 is rotated. As a result, the light beam is incident on a prescribed position in the circumferential direction of the transmission type optical deflection disk 310 to be transmitted through and emitted from the upper side disk face. At this time, the light beam is emitted to a direction corresponding to the inclination angle of the inclined face 333 of the optical deflection region 332 and is scanned over a prescribed angular range in the scanning direction “L1” as a light beam having a prescribed divergence angle.

In this embodiment, the light beam emitted from the light source device 10 is focused on an upper face or its vicinity of the transmission type optical deflection disk 310 in the first direction “L21” and, on the other hand, is reached to the upper face of the transmission type optical deflection disk 310 in a state of a divergent beam in the second direction “L22”. Therefore, the light beam emitted from the light source device 10 forms a radially extended spot on the upper face of the transmission type optical deflection disk 310. Accordingly, a width of the optical deflection region 332 which is formed in the transmission type optical deflection disk 310 may be narrow. As a result, a large number of optical deflection regions 332 can be formed even in a small transmission type optical deflection disk 310 and thus a high degree of resolution can be obtained.

Further, in the light beam scanning device 1g in this embodiment, a distance between the light emitting source 20 and the condenser lens 30 and a distance between the condenser lens 30 and the transmission type optical deflection disk 310 are set so that the light beam emitted from the light source device 10 is focused on the upper face or its vicinity of the transmission type optical deflection disk 310 in the first direction “L21”. Therefore, there is a restriction that a divergence angle of the light beam emitted from the transmission type optical deflection disk 310 cannot be set at a desired angle in the second direction “L22”. However, in this embodiment, the divergence angle modification lens 60 is disposed on a rear side of the transmission type optical deflection disk 310, and the divergence angle modification lens 60 is a cylindrical lens which has a positive power in the direction “L2” perpendicular to the scanning direction “L1” by the polygon mirror 210. Therefore, the divergence angle modification lens 60 sets a divergence angle of the light beam emitted from the transmission type optical deflection disk 310 at a desired angle in the direction “L2” (the first direction “L21”) which is perpendicular to the scanning direction “L1” scanned by the transmission type optical deflection disk 310. Therefore, according to the light beam scanning device 1g in this embodiment, a light beam can be scanned whose divergence angle in the direction “L2” which is perpendicular to the scanning direction “L1” is in a prescribed condition. As a result, when the light beam scanning device 1g is used as an inter-vehicle distance measuring device or a monitoring device, a light beam having a divergence angle which is prescribed by the divergence angle modification lens 60 can be scanned over an angular range prescribed by the transmission type optical deflection disk 310.

### Ninth Embodiment

FIG. 21 is a schematic perspective view schematically showing a state where a light beam is scanned in a light beam scanning device in accordance with a ninth embodiment of the present invention. A basic structure of the light beam scanning device in this embodiment is similar to that in the eighth embodiment and thus the same notational symbols are used for common portions and their detailed descriptions are omitted.

As shown in FIG. 21, in the light beam scanning device 1h in this embodiment, a condenser lens 30 in the light source device 10 guides a light beam emitted from the light emitting source 20 as a converged light beam which is focused on an upper face or its vicinity of the transmission type optical deflection disk 310 both in the first direction “L21” and in the second direction “L22” in which the first direction “L21” and the second direction “L22” are perpendicular to an optical axis direction.

Further, a disk face of the transmission type optical deflection disk 310 is divided into a plurality of radial optical deflection regions 332. Each of the plurality of the optical deflection regions 332 is formed with an inclined face 333 which is inclined to a radial direction at a constant angle.

In addition, also in the light beam scanning device 1h in this embodiment, similarly to the eighth embodiment, a divergence angle modification lens 60 is disposed for an emitted light beam from the optical deflection mechanism 300. The divergence angle modification lens 60 is a cylindrical lens which has a positive power only in the direction “L2” perpendicular to the scanning direction “L1” by the optical deflection mechanism 300 and which does not have a power in the scanning direction “L1”.

In the light beam scanning device 1h structured as described above, the light beam emitted from the light source device 10 is focused on the upper face or its vicinity of the transmission type optical deflection disk 310 both in the first direction “L21” and the second direction “L22”. Therefore, the light beam emitted from the light source device 10 forms a small spot on the upper face of the transmission type optical deflection disk 310. Accordingly, a width of the optical deflection region 332 formed in the transmission type optical deflection disk 310 may be narrow. Further, a diameter of the transmission type optical deflection disk 310 may be smaller. Therefore, according to this embodiment, even in a small transmission type optical deflection disk 310, a large number of optical deflection regions 332 can be formed and thus a high degree of resolution can be obtained.

Further, in the light beam scanning device 1h in this embodiment, a distance between the light emitting source 20 and the condenser lens 30 and a distance between the condenser lens 30 and the transmission type optical deflection disk 310 are set so that the light beam emitted from the light source device 10 is focused on the upper face or its vicinity of the transmission type optical deflection disk 310 both in the first direction “L21” and the second direction “L22”. Therefore, there is a restriction that a divergence angle of the light beam emitted from the transmission type optical deflection disk 310 cannot be set at a desired angle in the second direction “L22”. However, the divergence angle modification lens 60 sets a divergence angle of the light beam emitted from the transmission type optical deflection disk 310 at a desired angle in the direction “L2” which is perpendicular to the scanning direction “L1” by the transmission type optical deflection disk 310. Therefore, according to the light beam scanning device 1h in this embodiment, a light beam can be scanned whose divergence angle in the direction “L2” which is perpendicular to the scanning direction “L1” is in a prescribed condition.

### Tenth Embodiment

FIG. 22 is a schematic perspective view schematically showing a state where a light beam is scanned in a light beam scanning device in accordance with a tenth embodiment of the present invention. A basic structure of the light beam scanning device in this embodiment is similar to that in the eighth embodiment and thus the same notational symbols are used for common portions and their detailed descriptions are omitted.

As shown in FIG. 22, in the light beam scanning device 1i in this embodiment, a condenser lens 30 in the light source device 10 guides a light beam emitted from the light emitting source 20 as a converged light beam which is focused on an upper face or its vicinity of the transmission type optical deflection disk 310 in the second direction “L22” and guides to the upper face of the transmission type optical deflection disk 310 as a divergent beam in the first direction “L21” in which the first direction “L21” and the second direction “L22” are perpendicular to an optical axis direction.

Further, a disk face of the transmission type optical deflection disk 310 is divided into a plurality of radial optical deflection regions 332 and each of the plurality of the optical deflection regions 332 is formed with an inclined face 333 which is inclined to a radial direction at a constant angle.

Further, also in the light beam scanning device 1i in this embodiment, similarly to the eighth embodiment, a divergence angle modification lens 60 is disposed for an emitted light beam from the optical deflection mechanism 300. The divergence angle modification lens 60 is a cylindrical lens which has a positive power only in the direction “L2” perpendicular to the scanning direction “L1” by the optical deflection mechanism 300 and which does not have a power in the scanning direction “L1”.

In the light beam scanning device 1i structured as described above, the light beam emitted from the light source device 10 is focused on an upper face or its vicinity of the transmission type optical deflection disk 310 in the second direction “L22” and, on the other hand, is reached to the upper face of the transmission type optical deflection disk 310 in a state of a divergent beam in the first direction “L21”. Therefore, the light beam emitted from the light source device 10 forms a spot extended in the circumferential direction on the upper face of the transmission type optical deflection disk 310. Accordingly, a diameter of the transmission type optical deflection disk 310 may be small.

Further, in the light beam scanning device 1i in this embodiment, a distance between the light emitting source 20 and the condenser lens 30 and a distance between the condenser lens 30 and the transmission type optical deflection disk 310 are set so that the light beam emitted from the light source device 10 is focused on the upper face or its vicinity of the transmission type optical deflection disk 310 in the second direction “L22”. Therefore, there is a restriction that a divergence angle of the light beam emitted from the transmission type optical deflection disk 310 cannot be set at a desired angle in the first direction “L21”. However, in this embodiment, the divergence angle modification lens 60 sets a divergence angle of the light beam emitted from the transmission type optical deflection disk 310 at a desired angle in the direction “L2” (the first direction “L21”) which is perpendicular to the scanning direction “L1” by the transmission type optical deflection disk 310. Therefore, according to the light beam scanning device 1i in this embodiment, a light beam can be scanned whose divergence angle in the direction “L2” which is perpendicular to the scanning direction “L1” is in a prescribed condition. As a result, when the light beam scanning device 1i is used as an inter-vehicle distance measuring device or a monitoring device, a light beam having a divergence angle which is prescribed by the divergence angle modification lens 60 can be scanned over an angular range prescribed by the transmission type optical deflection disk 310.

### Eleventh Embodiment

FIG. 23 is a perspective view schematically showing a schematic structure of a refractive optical element which is used in a light beam scanning device in accordance with a eleventh embodiment of the present invention. A basic structure of the light beam scanning device in this embodiment is similar to that in the eighth embodiment and thus the same notational symbols are used for common portions and their detailed descriptions are omitted.

In the transmission type optical deflection disk 310 in accordance with the eighth, the ninth and tenth embodiments, a plurality of optical deflection regions 32 are formed in the circumferential direction and the inclined face 33 is formed on each of the optical deflection regions 32. However, the transmission type optical deflection disk 310 may be structured as shown in FIG. 23. A continuous inclined face 33 in a circumferential direction is formed on the transmission type optical deflection disk 310 and an inclination angle of the inclined face 33 in a radial direction is continuously varied in the circumferential direction.

The cross sections of the transmission type optical deflection disk 310 structured as described above, similarly to the eighth, the ninth and tenth embodiments, are shown like FIGS. 20(a), 20(b) and 20(c) when cut by the “X-X” line, the “Y-Y” line and the “Z-Z” line shown in FIG. 19. An inclination angle “θw” in the radial direction gradually increases or decreases in its circumferential direction. Therefore, when a light beam is incident on the transmission type optical deflection disk 310 while the transmission type optical deflection disk 310 is rotated, the light beam is refracted by the inclined face 33 to be scanned when transmitted through the transmission type optical deflection disk 310. In this case, it is possible that a laser is continuously oscillated to increase resolving power to the maximum possible extent.

In this embodiment, the inclination angle of the inclined face 33 of the transmission type optical deflection disk 310 is continuously varied also in the circumferential direction. However, an inclination variation in this direction can be ignored because the diameter of the incident beam is small and thus scanning in the tangential direction of the transmission type optical deflection disk 310 can be ignored.

### Twelfth Embodiment

FIG. 24 is a perspective view schematically showing a schematic structure of a refractive optical element which is used a light beam scanning device in accordance with a twelfth embodiment of the present invention. A basic structure of the light beam scanning device and the refractive optical element in this embodiment is similar to those in the fourth through the eleventh embodiments and thus the same notational symbols are used for common portions and their detailed descriptions are omitted.

The fourth through the eleventh embodiments described above are structured so that a light beam emitted from the light source device 10 is transmitted through the transmission type optical deflection disk 310. However, like a light beam scanning device 1j in which a traveling direction of a light beam is shown by the solid line in FIG. 24, it may be structured that a light beam which is emitted from the light source device 10 is reflected by a reflection type optical deflection disk 410 in an optical deflection mechanism 400. In this case, for example, a disk in which an upper face of the optical deflection disk 310 described in the fourth through the eleventh embodiments is modified to form as a reflection face may be used as a reflection type optical deflection disk 410. Further, like a case where the traveling direction of a light beam is shown by the alternate long and short dash line in FIG. 24, it may be structured that a light beam emitted from the light source device 10 is reflected by an under face of a reflection type optical deflection disk 410 in an optical deflection mechanism 400. In this case, for example, a disk in which an under face of the optical deflection disk 310 described in the fourth through the eleventh embodiments is formed as a reflection face may be used as a reflection type optical deflection disk 410.

Also in this case structured as described above, similarly to the fourth through the eleventh embodiments, a condenser lens 30 in the light source device 10 guides a light beam emitted from the light emitting source 20 as a converged light beam which is focused on the upper face or its vicinity of the reflection type optical deflection disk 410 in one of the first direction and the second direction which are perpendicular to an optical axis direction. Therefore, the light beam emitted from the light source device 10 is, for example, irradiated as a radially extended spot on an optical deflection region of the reflection type optical deflection disk 410 to be scanned as a light beam of a divergent beam having a prescribed radiation angle. Therefore, even in a small reflection type optical deflection disk 410, a large number of optical deflection regions can be formed.

Further, when the condenser lens 30 in the light source device 10 guides as a converged light beam which is focused on the upper face or its vicinity of the reflection type optical deflection disk 410 in both the first direction and the second direction which are perpendicular to an optical axis direction, a small spot in comparison with a conventional case is irradiated. Therefore, a size of the reflection type optical deflection disk 410 can be reduced.

Further, when the divergence angle modification lens 60 sets a divergence angle of a light beam emitted from the transmission type optical deflection disk 310 at a desired angle in the direction “L2” which is perpendicular to the scanning direction “L1” by the transmission type optical deflection disk 310, a light beam can be scanned whose divergence angle in the direction “L2” perpendicular to the scanning direction “L1” is in a prescribed condition.

### Other Embodiments

In every embodiment of the first through the twelfth embodiments, a cylindrical lens is used as the divergence angle modification lens 60 and thus a divergence angle can be adjusted only in a direction perpendicular to the scanning direction and a divergence angle in another direction can be prevented from being influenced. However, a toric lens or a toroidal lens may be used as the divergence angle modification lens 60, in which its light incidence face is a cylindrical face where a radius of curvature in a scanning direction is set to be equal to a distance between an optical deflection element and its light incidence face and, in which a radius of curvature in the scanning direction of its light emitting face is set to be equal to a distance between with the optical deflection element and its emitting face. In this case, in comparison with a case where a cylindrical lens is used as a divergence angle modification lens, the divergence angle can be adjusted only in a direction perpendicular to the scanning direction and the divergence angle in another direction can be surely prevented from being influenced.

In every embodiment of the first through the twelfth embodiments, an aspherical lens is used as the condenser lens 30. However, a toric lens, a toroidal lens or a cylindrical lens, at least one face of which is provided with a positive power, may be used. Further, the condenser lens may be structured such that its one face is provided with a condensing operation in the first direction and its the other face is provided with a condensing operation in the second direction. When combined with various lens shape as described above, desired condensing performances (for example, a focal length, condensing/divergence angles and a beam intensity distribution) or desired divergence performances (for example, condensing/divergence angles and a beam intensity distribution) can be realized.

In every embodiment of the first through the twelfth embodiments, a lens which is made of glass or resin may be used as the condenser lens 30 and the divergence angle modification lens 60. When a lens made of resin is used, a weight of the light beam scanning device can be reduced by a reduced weight amount of the lens. Further, since productivity of the lens can be improved, cost of the light beam scanning device can be reduced.

In the fourth through the eleventh embodiments, the inclined face 333 is formed only on the emitting face of the transmission type optical deflection disk 310 but it may be formed only on the incident face side. Further, the inclined face may be formed on both of the emitting face side and the incident face side. When the inclined face is formed on both sides, for example, the inclination angle of the incident face side may be the same angle over all the optical deflection regions 332.

Further, in the fourth through the eleventh embodiments, the transmission type optical deflection disk 310 is formed of resin but the transmission type optical deflection disk 310 may be formed of glass. In this case, since it is hardly affected by temperature variation, its temperature characteristic is stable and the light beam scanning device can be used under a high-temperature environment.

In addition, the inclined face 333 is not required to form over the entire circumference of the emitting side face of the transmission type optical deflection disk 310 and a flat face part may be formed on a part of the emitting side face.

In addition, the position detecting means may not be provided in the fourth through the eleventh embodiments. Like the embodiment as described above, in a case that the transmission type optical deflection disk 310 is structured of a plurality of optical deflection regions 332 which is divided in the circumferential direction at a substantially equal angular interval, when the motor 350 is controlled to rotate at a constant speed and a pulse-shaped light beam is emitted from the light source device 10 at a constant interval, appropriate scanning of a light beam can be performed.

In addition, instead of providing the mirror 305, it may be structured that a light beam is emitted to a disk face of the transmission type optical deflection disk 310 from the light source device 10 to directly incident on the transmission type optical deflection disk 310. Further, when the mirror 305 is provided, it may be structured that the light source device 10 is disposed on an obliquely down side of the transmission type optical deflection disk 310 and a light beam is incident on the transmission type optical deflection disk 310 from obliquely below the transmission type optical deflection disk 310.

Further, a divergence angle modification lens drive mechanism may be provided which drives the divergence angle modification lens 60 to move a scanning position of a light beam in a direction crossing the scanning direction “L1”. According to the structure as described above, a plurality of scanning lines can be structured. In accordance with an embodiment, the divergence angle modification lens drive mechanism may be structured in which at least one of inclination postures of the divergence angle modification lens 60 around an axial line which is parallel to the scanning direction “L1” is changed.

The above-mentioned embodiments are examples of preferred embodiments of the present invention. However, the present invention is not limited to these and many modifications can be made departing from the present invention.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1-23. (canceled)

24. A light beam scanning device comprising:
a light source device;
an optical deflection mechanism comprising an optical deflection disk and a rotational drive mechanism for rotationally driving the optical deflection disk for scanning a light beam which is emitted from the light source device over a prescribed angular range by the optical deflection disk; and
a divergence angle modification lens for varying a divergence angle of an emitted light beam from the optical deflection disk in at least a direction perpendicular to a scanning direction scanned by the optical deflection disk;
wherein the light source device comprises a light emitting source and a condenser lens which guides the light beam emitted from the light emitting source as a converged light beam which is focused on the optical deflection disk or its vicinity in at least one of a first direction and a second direction which are perpendicular to an optical axis direction;
wherein the optical deflection disk is provided on one of disk faces with a plurality of optical deflection regions which is formed in a circular ring shape and is divided in a circumferential direction of the disk face; and
wherein the plurality of the optical deflection regions formed in the circular ring shape is formed with an inclined face from which the light beam is emitted to a direction different from directions in adjacent optical deflection regions, and an emitting direction of the light beam is varied according to a position in a circumferential direction of the disk face of the optical deflection disk.

25. The light beam scanning device according to claim 24, wherein the plurality of the optical deflection regions is radially divided in the circumferential direction.

26. The light beam scanning device according to claim 25, wherein the inclined face inclines to a radial direction and the emitting direction of the light beam is varied in the circumferential direction by an inclination angle to the radial direction of the inclined face which is varied in the circumferential direction.

27. The light beam scanning device according to claim 25, wherein the inclined face inclines to the circumferential direction and the emitting direction of the light beam is varied in the circumferential direction by an inclination angle to the circumferential direction of the inclined face which is varied in the circumferential direction.

28. The light beam scanning device according to claim 24, wherein the inclined face inclines to a radial direction and the emitting direction of the light beam is varied in the circumferential direction by an inclination angle to the radial direction of the inclined face which is varied in the circumferential direction.

29. The light beam scanning device according to claim 28, wherein the divergence angle modification lens varies the divergence angle of the emitted light beam from the optical deflection disk only in a direction perpendicular to the scanning direction.

30. The light beam scanning device according to claim 29, wherein the divergence angle modification lens is a cylindrical lens.

31. The light beam scanning device according to claim 29, wherein the divergence angle modification lens is a toric lens or a toroidal lens whose light incidence face is a cylindrical face where a radius of curvature in the scanning direction is set to be equal to a distance between the optical deflection disk and the light incidence face and, in which a radius of curvature in the scanning direction of its light emitting face is set to be equal to a distance between the optical deflection disk and the light emitting face.

32. The light beam scanning device according to claim 28, further comprising a divergence angle modification lens drive mechanism for driving the divergence angle modification lens so as to move a scanning position of the light beam in a direction crossing the scanning direction.

33. The light beam scanning device according to claim 32, wherein the divergence angle modification lens drive mechanism changes an inclination posture of the divergence angle modification lens around an axial line which is parallel to the scanning direction.

34. The light beam scanning device according to claim 24, wherein the inclined face inclines to the circumferential direction and an emitting direction of the light beam is varied in the circumferential direction by an inclination angle to the circumferential direction of the inclined face which is varied in the circumferential direction.

35. The light beam scanning device according to claim 34, wherein the divergence angle modification lens varies the divergence angle of the emitted light beam from the optical deflection disk only in a direction perpendicular to the scanning direction.

36. The light beam scanning device according to claim 35, wherein the divergence angle modification lens is a cylindrical lens.

37. The light beam scanning device according to claim 35, wherein the divergence angle modification lens is a toric lens or a toroidal lens whose light incidence face is a cylindrical face where a radius of curvature in the scanning direction is set to be equal to a distance between the optical deflection disk and the light incidence face and, in which a radius of curvature in the scanning direction of its light emitting face is set to be equal to a distance between the optical deflection disk and the light emitting face.

38. The light beam scanning device according to claim 34, further comprising a divergence angle modification lens drive mechanism for driving the divergence angle modification lens so as to move a scanning position of the light beam in a direction crossing the scanning direction.

39. The light beam scanning device according to claim 38, wherein the divergence angle modification lens drive mechanism changes an inclination posture of the divergence angle modification lens around an axial line which is parallel to the scanning direction.

40. The light beam scanning device according to claim 24, wherein the optical deflection disk is a transmission type optical deflection disk through which a direction of the light beam transmitted and emitted is varied according to the position in the circumferential direction of the disk face.

41. The light beam scanning device according to claim 24, wherein the optical deflection disk is a reflection type optical deflection disk by which a direction of the light beam reflected and emitted is varied according to the position in the circumferential direction of the disk face.

42. A light beam scanning device comprising:
a light source device;
an optical deflection mechanism comprising an optical deflection disk and a rotational drive mechanism for rotationally driving the optical deflection disk for scanning a light beam which is emitted from the light source device over a prescribed angular range by the optical deflection disk; and
a divergence angle modification lens for varying a divergence angle of an emitted light beam from the optical deflection disk in at least a direction perpendicular to a scanning direction scanned by the optical deflection disk;
wherein the light source device is provided with a light emitting source and a condenser lens which guides the light beam emitted from the light emitting source as a converged light beam which is focused on the optical deflection disk or its vicinity in at least one of a first direction and a second direction which are perpendicular to an optical axis direction;
wherein the optical deflection disk is provided on one of disk faces with an optical deflection region which is formed in a circular ring shape in the circumferential direction of the disk face;
wherein the optical deflection region formed in the circular ring shape is formed with one or plural optical deflection regions which is provided with an inclined face for continuously varying an emitting direction of the light beam in the circumferential direction; and
wherein the emitting direction of the light beam is varied according to a position of the optical deflection region in the circumferential direction of the disk face.

43. The tight beam scanning device according to claim 42, wherein the inclined face inclines to a radial direction and the emitting direction of the light beam is varied in the circumferential direction by an inclination angle to the radial direction of the inclined face which is varied in the circumferential direction.

44. The light beam scanning device according to claim 42, wherein the inclined face inclines to the circumferential direction and the emitting direction of the light beam is varied in the circumferential direction by an inclination angle to the circumferential direction of the inclined face which is varied in the circumferential direction.

45. The light beam scanning device according to claim 42, wherein the divergence angle modification lens varies the divergence angle of the emitted light beam from the optical deflection disk only in a direction perpendicular to the scanning direction.

46. The light beam scanning device according to claim 45, wherein the divergence angle modification lens is a cylindrical lens.

47. The light beam scanning device according to claim 45, wherein the divergence angle modification lens is a toric lens or a toroidal lens whose light incidence face is a cylindrical face where a radius of curvature in the scanning direction is set to be equal to a distance between the optical deflection disk and the light incidence face and, in which a radius of curvature in the scanning direction of its light emitting face is set to be equal to a distance between the optical deflection disk and the light emitting face.
